(19) United States
(12) Patent Application Publication
(10) Pub. No.: US 2026/0168848 A1
(43) Pub. Date: Jun. 18, 2026

(54) ELECTROMAGNETIC WAVE DETECTOR AND ELECTROMAGNETIC WAVE DETECTOR ARRAY

(71) Applicant: Mitsubishi Electric Corporation, Tokyo (JP)

(72) Inventors: Shoichiro FUKUSHIMA, Chiyoda-ku, Tokyo (JP); Masaaki SHIMATANI, Chiyoda-ku, Tokyo (JP); Shimpei OGAWA, Chiyoda-ku, Tokyo (JP)

(73) Assignee: Mitsubishi Electric Corporation, Tokyo (JP)

(21) Appl. No.: 18/707,888

(22) PCT Filed: Dec. 6, 2022
(86) PCT No.: PCT/JP2022/044887

§ 371 Date: May 7, 2024

(30) Foreign Application Priority Data
Dec. 13, 2021 (JP) 2021-201911

(51) Int. Cl. G01J 1/44; G01J 5/20

(52) U.S. Cl. CPC G01J 1/44; G01J 5/20

(57) ABSTRACT

An electromagnetic wave detector includes: a two-dimensional material layer having a first portion, a second portion and a third portion, the second portion being disposed with a space being interposed between the first portion and the second portion in a first direction, the third portion being bridged between the first portion and the second portion in the first direction; a first electrode portion electrically connected to the first portion; a second electrode portion electrically connected to the first electrode portion via the first portion, the third portion, and the second portion of the two-dimensional material layer; and a ferroelectric layer at least having a portion disposed on the third portion.

### TECHNICAL FIELD

The present disclosure relates to an electromagnetic wave detector and an electromagnetic wave detector array.

### BACKGROUND ART

As a next-generation electromagnetic wave detector, there has been known an electromagnetic wave detector including a two-dimensional material layer such as graphene as an electromagnetic wave detection layer, for example. The two-dimensional material layer has very high mobility, but has a relatively low quantum efficiency. In recent years, sensitivity of such an electromagnetic wave detector including the two-dimensional material layer has been increased.

For example, WO 2018/012076 (PTL 1) proposes an electromagnetic wave detector including a ferroelectric layer disposed below or above a graphene layer connected between a source electrode and a drain electrode. In the detector, when an electromagnetic wave enters, in particular, when an electromagnetic wave in an infrared wavelength range enters, the ferroelectric layer exhibits a pyroelectric effect. This pyroelectric effect causes a change in dielectric polarization in the ferroelectric layer, with the result that a gate voltage of the graphene layer is modulated. Since the graphene layer has large atomic layer thickness and high charge mobility, a slight change in gate voltage leads to an enormous change in current response. Such an effect is referred to as a photogating effect. High sensitivity can be realized by this photogating effect.

### CITATION LIST

### Patent Literature

PTL 1: WO 2018/012076

### SUMMARY OF INVENTION

### Technical Problem

However, in the above-described detector, since a transistor operation is performed during a high-sensitivity operation in which a source-drain voltage is applied to the graphene, it is difficult to turn off the detector. Further, since the pyroelectric effect caused in the ferroelectric layer has been conventionally used, the response speed is low.

It is a main object of the present disclosure to provide an electromagnetic wave detector that uses a two-dimensional material layer, that attains high detection sensitivity and high response speed, and that can be turned off.

### Solution to Problem

An electromagnetic wave detector according to the present disclosure includes: a two-dimensional material layer having a first portion, a second portion, and a third portion, the second portion being disposed with a space being interposed between the first portion and the second portion in a first direction, the third portion being bridged between the first portion and the second portion in the first direction; a first electrode portion electrically connected to the first portion; a second electrode portion electrically connected to the first electrode portion via the first portion, the third portion, and the second portion of the two-dimensional material layer; and a ferroelectric layer at least having a portion disposed on the third portion.

### ADVANTAGEOUS EFFECTS OF INVENTION

According to the present disclosure, it is possible to provide an electromagnetic wave detector that uses a two-dimensional material layer, that attains high detection sensitivity and high response speed, and that can be turned off.

### BRIEF DESCRIPTION OF DRAWINGS

FIG. 1 is a schematic plan view of an electromagnetic wave detector according to a first embodiment.

FIG. 2 is a schematic cross sectional view along a line segment II-II in FIG. 1.

FIG. 3 is a flowchart for illustrating a method of manufacturing the electromagnetic wave detector according to the first embodiment.

FIG. 4 is a diagram for specifically illustrating a principle of operation in response to a pyroelectric effect of a ferroelectric layer in the electromagnetic wave detector according to the first embodiment.

FIG. 5 is a diagram for specifically illustrating a principle of operation in response to the pyroelectric effect and an inverse piezoelectric effect of the ferroelectric layer in the electromagnetic wave detector according to the first embodiment.

FIG. 6 is a schematic plan view showing a first modification of the electromagnetic wave detector according to the first embodiment.

FIG. 7 is a schematic cross sectional view along a line segment VII-VII in FIG. 6.

FIG. 8 is a schematic plan view of an electromagnetic wave detector according to a second embodiment.

FIG. 9 is a schematic cross sectional view along a line segment IX-IX in FIG. 8.

FIG. 10 is a diagram for illustrating a change in absorption electromagnetic wave wavelength of a two-dimensional material layer under application of voltage at a resonance frequency in the electromagnetic wave detector according to the second embodiment.

FIG. 11 is a schematic cross sectional view of an electromagnetic wave detector according to a third embodiment.

FIG. 12 is a schematic cross sectional view along a line segment XII-XII of FIG. 11.

FIG. 13 is a schematic cross sectional view of an electromagnetic wave detector according to a fourth embodiment.

FIG. 14 is a schematic cross sectional view of an electromagnetic wave detector according to a fifth embodiment.

FIG. 15 is a schematic cross sectional view of an electromagnetic wave detector according to a sixth embodiment.

FIG. 16 is a schematic plan view of an electromagnetic wave detector according to a seventh embodiment.

FIG. 17 is a schematic plan view showing a first modification of the electromagnetic wave detector according to the seventh embodiment.

FIG. 18 is a schematic plan view of an electromagnetic wave detector according to an eighth embodiment.

FIG. 19 is a schematic cross sectional view along a line segment XIX-XIX in FIG. 18.

FIG. 20 is a top view of an electromagnetic wave detector array according to a ninth embodiment.

FIG. 21 is a schematic diagram showing an exemplary reading circuit to read out an electric signal obtained from the electromagnetic wave detector array according to the ninth embodiment.

FIG. 22 is a top view showing a first modification of the electromagnetic wave detector array according to the ninth embodiment.

### DESCRIPTION OF EMBODIMENTS

Hereinafter, embodiments will be described with reference to figures. It should be noted that in the description below, the same or corresponding portions are denoted by the same reference characters and the same explanation will not be described repeatedly.

In each of the embodiments described below, each figure is schematic and conceptually illustrates a function or structure. Further, the present disclosure is not limited by the embodiments described below. A basic configuration of an electromagnetic wave detector is the same among all the embodiments unless stated particularly. Further, the same or corresponding components are denoted by the same reference characters as described above. This applies to the entirety of the specification.

In each of the embodiments described below, a configuration of the electromagnetic wave detector when detecting visible light or infrared light will be described; however, the light detected by the electromagnetic wave detector of the present disclosure is not limited to the visible light or the infrared light. Each of the embodiments described below is effective as a detector to detect electric waves such as X-rays, ultraviolet light, near infrared light, terahertz (THz) wave, and microwave in addition to the visible light and the infrared light. It should be noted that in each of the embodiments of the present disclosure, the light and electric waves will be collectively referred to as “electromagnetic wave”.

Further, in the present embodiment, each of the terms “p type graphene” and “n type graphene” may be used as a graphene. In each of the embodiments described below, the p type graphene represents a graphene having a larger number of positive holes than those of a graphene in an intrinsic state, and the n type graphene represents a graphene having a larger number of electrons than those of the graphene in the intrinsic state. That is, an n type material is a material having an electron donating property. On the other hand, a p type material is a material having an electron attracting property.

Further, a material in which electrons are dominant when imbalance in charges is observed in a whole molecule may be referred to as n type. A material in which positive holes are dominant when imbalance in charges is observed in the whole molecule may be referred to as p type. One of an organic substance and an inorganic substance or a mixture of the organic substance and the inorganic substance may be used as a material of a member in contact with the graphene, which is an exemplary two-dimensional material layer.

Further, a plasmon resonance phenomenon such as a surface plasmon resonance phenomenon, which is an interaction between a metal surface and light, a phenomenon called pseudo surface plasmon resonance, which means resonance for a metal surface in a range other than a visible light range and a near infrared light range, and a phenomenon called metamaterial or metasurface or plasmonic metamaterial, which means manipulation of a wavelength by a structure having a size equal to or less than a wavelength will not be particularly distinguished from one another by the names and will be handled in an equivalent manner in terms of effects exerted by the phenomena. Here, each of these resonances will be referred to as surface plasmon resonance, plasmon resonance, or, simply, resonance.

In each of the embodiments described below, the graphene is described as an exemplary material of the two-dimensional material layer; however, the material of the two-dimensional material layer is not limited to the graphene. For example, as the material of the two-dimensional material layer, each of the following materials can be applied: transition metal dichalcogenide (TMD), black phosphorus, silicene (two-dimensional honeycomb structure by silicon atoms), germanene (two-dimensional honeycomb structure by germanium atoms), and the like. Examples of the transition metal dichalcogenide include transition metal dichalcogenides such as molybdenum disulfide (MoS₂), tungsten disulfide (WS₂), and tungsten diselenide (WSe₂).

More preferably, the two-dimensional material layer may include any material selected from a group consisting of graphene, the transition metal dichalcogenide (TMD), black phosphorus, silicene (two-dimensional honeycomb structure by silicon atoms), a graphene nanoribbon, and borophene, or may be formed by layering a plurality of layers of each of these materials.

Each of these materials has a structure similar to that of the graphene. In each of these materials, atoms are arranged in the form of a single layer in a two-dimensional plane. Therefore, also when each of these materials is applied to the two-dimensional material layer, the same functions and effects as those when the graphene is applied to the two-dimensional material layer can be obtained.

Further, the two-dimensional material layer may be formed as a multilayer graphene in which two or more single-layer graphene layers are layered. As the two-dimensional material layer, a non-doped graphene may be used or a graphene doped with a p type or n type impurity may be used. When the multilayer graphene is used for the two-dimensional material layer, photoelectric conversion efficiency of the two-dimensional material layer is increased to result in high sensitivity of the electromagnetic wave detector. In the multilayer graphene used as two-dimensional material layer 1, orientations of lattice vectors of hexagonal lattices in any two layers of the graphene may or may not be matched with each other. For example, by layering two or more layers of the graphene, a band gap is formed in the two-dimensional material layer. As a result, a wavelength selection effect for an electromagnetic wave to be subjected to photoelectric conversion can be provided. It should be noted that when the number of layers in the multilayer graphene that constitutes the two-dimensional material layer is increased, carrier mobility in a channel region is decreased. On the other hand, in this case, the two-dimensional material layer is less likely to be affected by carrier scattering from an underlying structure such as a substrate, thus resulting in decreased noise level. Therefore, in the electromagnetic wave detector using the multilayer graphene as the two-dimensional material layer, electromagnetic wave absorption is increased to result in increased detection sensitivity for the electromagnetic wave.

Also, when the two-dimensional material layer is in contact with an electrode, the two-dimensional material layer is doped with carriers from the electrode. For example, when gold (Au) is used as a material of the electrode, the two-dimensional material layer in the vicinity of the electrode is doped with positive holes due to a difference in work function between the two-dimensional material layer and Au. In this state, when the electromagnetic wave detector is driven in an electron conduction state, mobility of electrons flowing in the channel region of the two-dimensional material layer is decreased due to an influence of the positive holes with which the two-dimensional material layer is doped from the electrode, thus resulting in increased contact resistance between the two-dimensional material layer and the electrode. Due to the increased contact resistance, the mobility of electrons (carriers) due to an electric field effect in the electromagnetic wave detector can be decreased to result in decreased performance of the electromagnetic wave detector. In particular, when the single-layer graphene is used as the two-dimensional material layer, a doping amount of carriers injected from the electrode is large. Therefore, the decreased mobility of electrons in the electromagnetic wave detector is particularly significant when the single-layer graphene is used as the two-dimensional material layer. Therefore, when the two-dimensional material layer is entirely composed of the single-layer graphene, the performance of the electromagnetic wave detector may be decreased.

Therefore, a region in contact with the electrode may be composed of a multilayer graphene. In the multilayer graphene, an amount of carrier doping from the electrode is smaller than that in the single-layer graphene. Therefore, the contact resistance between the two-dimensional material layer and the electrode can be suppressed from being increased. As a result, the above-described decreased mobility of electrons in the electromagnetic wave detector can be suppressed, thus resulting in improved performance of the electromagnetic wave detector.

As the two-dimensional material layer, a nanoribbon-shaped graphene (hereinafter also referred to as “graphene nanoribbon”) can also be used. In that case, as the two-dimensional material layer, for example, a sole graphene nanoribbon, a composite in which a plurality of graphene nanoribbons are layered, or a structure in which a graphene nanoribbon is arranged periodically on a plane is used. For example, when the structure in which the graphene nanoribbon is arranged periodically is used as the two-dimensional material layer, plasmon resonance can be generated in the graphene nanoribbon. As a result, the sensitivity of the electromagnetic wave detector can be improved. Here, the structure in which the graphene nanoribbon is arranged periodically may be also referred to as “graphene metamaterial”. Therefore, the above-described effect is obtained also in the electromagnetic wave detector using the graphene metamaterial as the two-dimensional material layer.

The multilayer graphene may have a turbostratic layer stack, which is not an AB layer stack seen in a graphite in which a layer stacking azimuth angle is in a natural state. The turbostratic layer stack is also referred to as “random layer stack” or “turbostratic graphene”. A method of producing a turbostratic structure portion may be appropriately determined. For example, a turbostratic structure portion 1T may be formed in the following manner: a single-layer graphene produced by a CVD method is transferred a plurality of times, thereby layering the multilayer graphene. Alternatively, the turbostratic structure portion may be formed in the following manner: ethanol, methane, or the like is disposed on the graphene as a carbon source and the graphene is grown by a CVD method.

Further, in the present embodiment, the term “insulating layer” represents a layer of an insulating film having a thickness with which no tunnel current is generated.

The material of the insulating layer is, for example, silicon oxide (SiO₂). The material of the insulating layer is not limited to silicon oxide, and may be, for example, tetraethyl orthosilicate (Si(OC₂H₅)₄), silicon nitride (Si₃N₄), hafnium oxide (HfO₂), aluminum oxide (Al₂O₃), nickel oxide (NiO), boron nitride (BN), or a siloxane-based polymer material. For example, an atomic arrangement of boron nitride (BN) is similar to that of graphene. Therefore, when boron nitride (BN) is in contact with the two-dimensional material layer composed of graphene, the electron mobility of the two-dimensional material layer is suppressed from being decreased. Therefore, boron nitride (BN) is suitable for an insulating layer serving as an underlying film disposed below the two-dimensional material layer.

A material of a ferroelectric layer may be appropriately determined as long as polarization occurs when an electromagnetic wave having a detection wavelength enters the ferroelectric layer. The material of a ferroelectric layer 5 include, for example, at least one of barium titanate (BaTiO₃), lithium niobate (LiNbO₃), lithium tantalate (LiTaO₃), strontium titanate (SrTiO₃), lead zirconate titanate (PZT), strontium bismuth tantalate (SBT), bismuth ferrite (BFO), zinc oxide (ZnO), hafnium oxide (HfO₂), and a polyvinylidene-fluoride-based ferroelectric material (PVDF, P(VDF-TrFE), P(VDF-TrFE-CTFE), or the like), which is an organic polymer. Further, ferroelectric layer 5 may be formed by layering or mixing a plurality of different ferroelectric materials.

The material of the ferroelectric layer is not limited to the above-described materials as long as the material of the ferroelectric layer is a pyroelectric material that exhibits a pyroelectric effect. Specifically, the material of the ferroelectric layer may be a ferroelectric material in which polarization is changed in response to a change in thermal energy inside the ferroelectric layer. It should be noted that in the pyroelectric effect, the electromagnetic wave simply acts as a heat source. Therefore, the pyroelectric effect basically has no wavelength dependency. Hence, ferroelectric layer 5 basically has no wavelength dependency. Therefore, the ferroelectric layer has sensitivity for electromagnetic waves in wide bands.

Examples of a material of a semiconductor layer include: silicon (Si); germanium (Ge); a compound semiconductor such as a III-V semiconductor or a II-V semiconductor; mercury cadmium telluride (HgCdTe); iridium antimonide (InSb), lead selenide (PbSe), lead sulfide (PbS), cadmium sulfide (CdS), gallium nitride (GaN), silicon carbide (SiC), gallium phosphide (GaP), indium gallium arsenide (InGaAs), and indium arsenide (InAs). The semiconductor layer may be a substrate including a quantum well or a quantum dot. The material of the semiconductor layer may be a Type II superlattice. The Type II superlattice may have a film structure called a barrier type. The semiconductor layer may have a multilayer structure, and a pn junction photodiode, a pin photodiode, a Schottky photodiode, or an avalanche photodiode may be used. A phototransistor may be used as the semiconductor layer. The material of the semiconductor layer may be one of the above-described materials or a combination of the above-described materials. When the material of the semiconductor layer is the combination of the above-described semiconductor materials, the electromagnetic wave detector including the semiconductor layer can detect multiple wavelengths. The semiconductor layer is preferably doped with an impurity so as to have an electric resistivity of 100 Ω·cm or less. When the semiconductor layer is doped at a high concentration, mobility speed (reading speed) of carriers in the semiconductor layer becomes fast. This results in improved response speed of the electromagnetic wave detector.

### First Embodiment

### Configuration of Electromagnetic Wave Detector

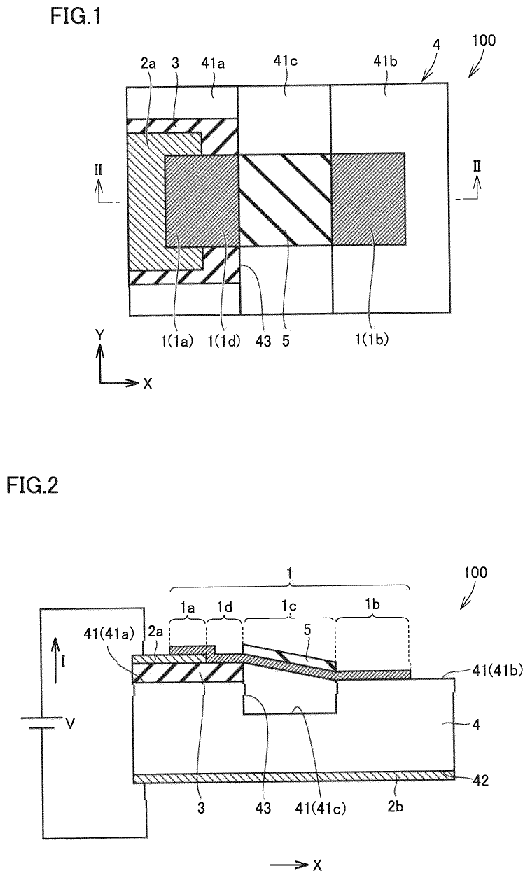

FIG. 1 is a schematic plan view of an electromagnetic wave detector according to a first embodiment. FIG. 2 is a schematic cross sectional view along a line segment II-II of FIG. 1. FIG. 2 also shows typical electric connection of electromagnetic wave detector 100. The electromagnetic wave detector shown in FIGS. 1 and 2 mainly includes a two-dimensional material layer 1, a first electrode portion 2a, a second electrode portion 2b, an insulating layer 3, a semiconductor layer 4, and a ferroelectric layer 5.

Semiconductor layer 4 has a first surface 41 and a second surface 42 located opposite to first surface 41. Each of first surface 41 and second surface 42 extends along a first direction X and a second direction Y orthogonal to first direction X.

First surface 41 has: a first region 41a; a second region 41b disposed with a space being interposed between first region 41a and second region 41b in first direction X; and a third region 41c disposed between first region 41a and second region 41b in first direction X. Each of first region 41a and second region 41b is, for example, a flat surface. Second region 41b and first region 41a are provided to form the same flat surface, for example. Semiconductor layer 4 is provided with a recess 43 recessed from each of first region 41a and second region 41b. Recess 43 extends, for example, along second direction Y. Third region 41c is a bottom surface of recess 43, for example. It should be noted that third region 41c may be provided to form the flat surface together with each of first region 41a and second region 41b.

Insulating layer 3 is disposed on first region 41a of first surface 41. Insulating layer 3 is not disposed on second region 41b and third region 41c of first surface 41, and second region 41b and third region 41c are exposed therefrom.

First electrode portion 2a is disposed on a portion of the upper surface of insulating layer 3. First electrode portion 2a is electrically connected to a first portion la of two-dimensional material layer 1. Second electrode portion 2b is disposed on second surface 42 of semiconductor layer 4. Second electrode portion 2b is electrically connected to semiconductor layer 4. Second electrode portion 2b is electrically connected to first electrode portion 2a via two-dimensional material layer 1 and semiconductor layer 4.

Two-dimensional material layer 1 is provided on first electrode portion 2a, insulating layer 3, and semiconductor layer 4. Two-dimensional material layer 1 is electrically connected to first electrode portion 2a. Two-dimensional material layer 1 extends from the upper surface of first electrode portion 2a to the upper surface of insulating layer 3. Two-dimensional material layer 1 is electrically connected to semiconductor layer 4.

More specifically, two-dimensional material layer 1 mainly includes first portion 1a, a second portion 1b, a third portion 1c, and a fourth portion 1d. First portion 1a, fourth portion 1d, third portion 1c, and second portion 1b are connected in this order in first direction X. For example, two-dimensional material layer 1 has a long-side direction along first direction X and a short-side direction along second direction Y when viewed in a plan view.

First portion 1a and fourth portion 1d are disposed on first region 41a of first surface 41 of semiconductor layer 4. First portion 1a is electrically connected to first electrode portion 2a on insulating layer 3. First portion 1a is in contact with the upper surface of first electrode portion 2a, for example. It should be noted that first portion 1a may be in contact with the lower surface of first electrode portion 2a. Fourth portion 1d connects between first portion 1a and third portion 1c. Fourth portion 1d is in contact with the upper surface of insulating layer 3.

Second portion 1b is disposed with a space being interposed between first portion 1a and second portion 1b in first direction X. Second portion 1b is in contact with second region 41b of first surface 41 of semiconductor layer 4. Second portion 1b is electrically connected to semiconductor layer 4. Preferably, second portion 1b is in Schottky junction with semiconductor layer 4.

Third portion 1c is bridged between first region 41a and second region 41b of semiconductor layer 4 in first direction X. Third portion 1c is disposed above third region 41c of first surface 41 of semiconductor layer 4. Unlike each of first portion la and second portion 1b, third portion 1c is not in contact with each of first electrode portion 2a, insulating layer 3, and semiconductor layer 4. For example, third portion 1c is provided to be deformed when the temperature of third portion 1c is changed.

Respective thicknesses of first portion 1a, second portion 1b, third portion 1c, and fourth portion 1d of two-dimensional material layer 1 may be the same. The upper surface of two-dimensional material layer 1 may be provided with unevenness resulting from first portion 1a, second portion 1b, third portion 1c, and fourth portion 1d.

Ferroelectric layer 5 is disposed on third portion 1c of two-dimensional material layer 1. The lower surface of ferroelectric layer 5 is in contact with the upper surface of third portion 1c. Ferroelectric layer 5 is electrically connected to third portion 1c of two-dimensional material layer 1.

It should be noted that the upper surface of ferroelectric layer 5 may be in contact with the lower surface of third portion 1c. Ferroelectric layer 5 is not in contact with each of first electrode portion 2a, insulating layer 3, and semiconductor layer 4. It should be noted that ferroelectric layer 5 may be in contact with insulating layer 3.

Ferroelectric layer 5 has sensitivity for a wavelength (hereinafter also referred to as “detection wavelength”) of an electromagnetic wave to be detected by electromagnetic wave detector 100. When the electromagnetic wave having the detection wavelength is applied to ferroelectric layer 5, dielectric polarization is changed in ferroelectric layer 5. Ferroelectric layer 5 is provided to be deformed together with third portion 1c of two-dimensional material layer 1 by an inverse piezoelectric effect when the dielectric polarization is changed in ferroelectric layer 5. In other words, ferroelectric layer 5 is provided to deform third portion 1c of two-dimensional material layer 1 when the electromagnetic wave having the detection wavelength is applied to ferroelectric layer 5, thereby changing a resistance value of third portion 1c.

Preferably, ferroelectric layer 5 is configured such that a speed of change of the dielectric polarization in ferroelectric layer 5 is as fast as possible. For example, the thickness (film thickness) of ferroelectric layer 5 is as thin as possible to such an extent that voltage can be applied between two-dimensional material layer 1 and semiconductor layer 4.

### Method of Manufacturing Electromagnetic Wave Detector

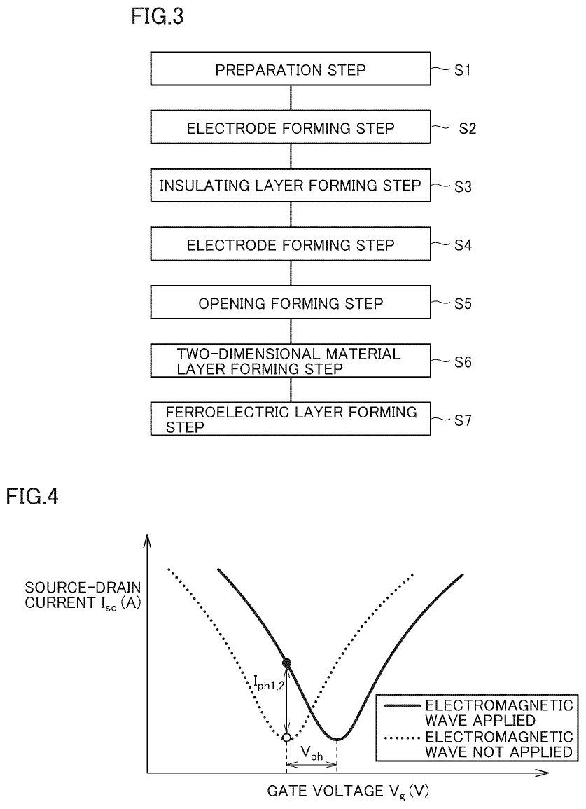

FIG. 3 is a flowchart for illustrating a method of manufacturing the electromagnetic wave detector according to the first embodiment. The method of manufacturing the electromagnetic wave detector shown in FIGS. 1 and 2 will be described with reference to FIG. 3.

First, a preparation step (S1) shown in FIG. 3 is performed. In this step (S1), semiconductor layer 4, which is a flat substrate composed of, for example, silicon or the like, is prepared.

Next, an electrode forming step (S2) is performed. In this step (S2), second electrode portion 2b is formed on the rear surface of semiconductor layer 4. Specifically, first, a protective film is formed on the front surface of semiconductor layer 4. As the protective film, for example, a resist is used. In this state, second electrode portion 2b is formed on the rear surface of semiconductor layer 4. Examples of the material of second electrode portion 2b include metals such as gold (Au), silver (Ag), copper (Cu), aluminum (Al), nickel (Ni), and chromium (Cr). On this occasion, in order to attain improved close contact between semiconductor layer 4 and second electrode portion 2b, a close-contact layer may be formed on the rear surface of semiconductor layer 4 before forming second electrode portion 2b. As the material of the close-contact layer, copper (Cr) or titanium (Ti) is used, for example. It should be noted that the step (S2) may be performed after steps (S3 to 7) as long as the front surface of semiconductor layer 4 is protected.

Next, an insulating layer forming step (S3) is performed. In this step (S3), insulating layer 3 is formed on the front surface of semiconductor layer 4. When semiconductor layer 4 is silicon, insulating layer 3 may be silicon oxide (SiO2) formed by thermally oxidizing a portion of the front surface of semiconductor layer 4, for example. Alternatively, the insulating layer may be formed on the front surface of semiconductor layer 4 by a CVD (Chemical Vapor Deposition) method or a sputtering method.

Next, an electrode forming step (S4) is performed. In this step (S4), first electrode portion 2a is formed on insulating layer 3. Examples of the material of first electrode portion 2a include metals such as gold (Au), silver (Ag), copper (Cu), aluminum (Al), nickel (Ni), and chromium (Cr). On this occasion, in order to attain improved close contact between first electrode portion 2a and insulating layer 3, a close-contact layer may be formed between insulating layer 3 and first electrode portion 2a. As the material of the close-contact layer, chromium (Cr), titanium (Ti), or the like is used, for example.

As a method of forming first electrode portion 2a, for example, the following process is used. First, a resist mask is formed on the surface of insulating layer 3 using photoengraving, EB lithography, or the like. In the resist mask, an opening is formed in conformity with a region in which first electrode portion 2a is to be formed. Then, a film of a metal or the like to be first electrode portion 2a is formed on the resist mask. The film is formed using a vapor deposition method, a sputtering method, or the like. On this occasion, the film is formed to extend from the inside of the opening of the resist mask to the upper surface of the resist mask. Then, the resist mask is removed together with a portion of the film, with the result that the other portion of the film in the opening of the resist mask remains on the surface of insulating layer 3 and serves as first electrode portion 2a. The above-described method is a method generally referred to as “lift-off”.

As the method of forming first electrode portion 2a, another method may be used. For example, a film such as a metal film to be first electrode portion 2a is first formed on the surface of insulating layer 3. Then, a resist mask is formed on the film by a photolithography method. The resist mask is formed to cover a region in which first electrode portion 2a is to be formed, and is not formed on a region other than the region in which first electrode portion 2a is to be formed. Then, the film is partially removed by wet etching or dry etching using the resist mask as a mask. As a result, a portion of the film remains under the resist mask. This portion of the film serves as first electrode portion 2a. Then, the resist mask is removed. In this way, first electrode portion 2a may be formed.

Next, an opening forming step (S5) is performed. In this step (S5), an opening is formed in each of insulating layer 3 and semiconductor layer 4. Specifically, a resist mask is formed on insulating layer 3 by photoengraving, EB lithography, or the like. In the resist mask, an opening is formed in conformity with a region in which an opening of insulating layer 3 is to be formed. Then, insulating layer 3 is partially removed by wet etching or dry etching using the resist mask as a mask, thereby forming the opening. Next, the resist mask is removed. Next, a resist mask is formed on insulating layer 3 and semiconductor layer 4 by photoengraving, EB photolithography, or the like. In the resist mask, an opening is formed in conformity with a region in which an opening of semiconductor layer 4 is to be formed. Then, semiconductor layer 4 is partially removed by wet etching or dry etching using the resist mask as a mask, thereby forming the opening. Next, the resist mask is removed. It should be noted that the step (S5) may be performed prior to the step (S4).

Next, a two-dimensional material layer forming step (S6) is performed. In this step (S6), two-dimensional material layer 1 is formed to cover first electrode portion 2a, insulating layer 3, and a whole of the exposed portion of semiconductor layer 4 in the opening of insulating layer 3. As the material of two-dimensional material layer 1, for example, an atomic layer material, such as graphene, or molecular layer material may be used. Two-dimensional material layer 1 may be formed by any method. For example, two-dimensional material layer 1 may be formed by epitaxial growth, or two-dimensional material layer 1 formed in advance by a CVD method may be transferred and attached onto first electrode portion 2a, insulating layer 3, and the portion of semiconductor layer 4. Alternatively, two-dimensional material layer 1 may be formed by screen printing or the like. Alternatively, two-dimensional material layer 1 detached by mechanical detachment or the like may be transferred onto first electrode portion 2a or the like. Next, a resist mask is formed on two-dimensional material layer 1 using photoengraving or the like. The resist mask is formed to cover a region in which two-dimensional material layer 1 is to remain, but is not formed on a region in which two-dimensional material layer 1 is not to remain. Then, two-dimensional material layer 1 is partially removed by etching with oxygen plasma using the resist mask as a mask. Thus, an unnecessary portion of the two-dimensional material layer is removed to form two-dimensional material layer 1 as shown in FIGS. 1 and 2. Then, the resist mask is removed. Preferably, when viewed in a plan view, the area of fourth portion 1d of two-dimensional material layer 1 provided as a region in contact with insulating layer 3 is equal to or larger than the area of third portion 1c provided as a bridged region. In the electromagnetic wave detector, thermal contraction and expansion occur in response to a temperature change during electromagnetic wave application and voltage application operation. Since insulating layer 3 is deformed by an amount smaller than that of each of electrode 2 and semiconductor layer 4 in response to the temperature change and also has thermal conductivity lower than that of each of electrode 2 and semiconductor layer 4, insulating layer 3 is less likely to cause positional displacement and thermal conduction in response to the temperature change when insulating layer 3 is brought into contact with two-dimensional material layer 1, with the result that insulating layer 3 is in very close contact with two-dimensional material layer 1. Third portion 1c of two-dimensional material layer 1 provided in the electromagnetic wave detector according to the present embodiment has the bridged structure, and is more likely to be detached or broken than the other portions supported by the underlying structures; however, by providing fourth portion 1d as a layer in close-contact with insulating layer 3, two-dimensional material layer 1 can be suppressed from being detached or broken, thus resulting in improved structural strength.

Next, a ferroelectric layer forming step (S7) is performed. In this step (S7), ferroelectric layer 5 is formed on two-dimensional material layer 1. Examples of the material for forming ferroelectric layer 5 may include BaTiO₃ (barium titanate), LiNbO₃ (lithium niobate), LiTaO₃ (lithium tantalate), SrTiO₃ (strontium titanate), PZT (lead zirconate titanate), SBT (strontium bismuth tantalate), BFO (bismuth ferrite), ZnO (zinc oxide), HfO₂ (hafnium oxide), and a polyvinylidene-fluoride-based ferroelectric material, which is an organic polymer. Further, ferroelectric layer 5 may be formed by any method. For example, when ferroelectric layer 5 is composed of a polymer-based material, a polymer film is formed by a spin coating method or the like, and then is processed by a photolithography method. In the case of another material, a film is formed by sputtering, vapor deposition, MOD (Metal Organic Composition) coating method, or the like, and then patterning is performed using a photolithography method. Alternatively, the method called “lift-off” may be used in which a ferroelectric material is formed using a resist mask as a mask and then the resist mask is removed. Further, ferroelectric layer 5 may be formed by an atomic layer deposition method. Here, the number of molecular layers of the ferroelectric layer formed by the atomic layer deposition method is desirably 1000 or less. By reducing the number of molecular layers as compared with a bulk material, thermal capacity is reduced as compared with the case where the bulk material is used, a time constant of the pyroelectric effect at the time of application of electromagnetic wave is improved, and a response speed to the application of electromagnetic wave is improved. Further, as compared with the case where the bulk material is used, a capacitance is improved to improve the pyroelectric effect, thereby improving the detection sensitivity of the electromagnetic wave detector. Further, since ferroelectric layer 5 is formed by a precursor material being adsorbed to two-dimensional material layer 1 in the atomic layer deposition method, the molecular structure of two-dimensional material layer 1 is not broken or distorted as compared with the case where ferroelectric layer 5 is formed by sputtering or vapor deposition. Therefore, performance of the electromagnetic wave detector can be improved without causing reduced detection sensitivity and increased noise due to reduced electric property of two-dimensional material layer 1. It should be noted that the step (S7) may be performed prior to the step (S6) and ferroelectric layer 5 and two-dimensional material layer 1 may be simultaneously formed in the step (S6).

By the above steps (S1 to S7), the electromagnetic wave detector shown in FIGS. 1 and 2 is obtained. It should be noted that two-dimensional material layer 1 is formed on first electrode portion 2a in the above-described manufacturing method; however, two-dimensional material layer 1 may be formed on insulating layer 3 in advance and first electrode portion 2a may be formed to overlap with a portion of two-dimensional material layer 1. However, when this structure is used, a contrivance is required to avoid process damage on two-dimensional material layer 1 at the time of forming first electrode portion 2a. As such a contrivance, for example, it is conceivable to form first electrode portion 2a in a state in which a region of two-dimensional material layer 1 other than the region with which first electrode portion 2a is to be formed to overlap is covered with a protective film or the like in advance.

Further, ferroelectric layer 5 is formed on two-dimensional material layer 1 in the above-described manufacturing method; however, two-dimensional material layer 1 may be formed on ferroelectric layer 5 formed on insulating layer 3 in advance. However, when this structure is used, a contrivance is required to avoid process damage on ferroelectric layer 5 and two-dimensional material layer 1 at the time of forming the opening of semiconductor layer 4. As such a contrivance, for example, it is conceivable to attain improved close contact between ferroelectric layer 5 and two-dimensional material layer 1 by performing calcination after forming two-dimensional material layer 1 so as to remove a residue such as moisture therebetween. Conditions for the calcination, such as atmosphere and temperature, are desirably set to remove the moisture and the resist and avoid process damage on first electrode portion 2a, second electrode portion 2b, insulating layer 3, and semiconductor layer 4. For example, the calcination is performed at 150° C. under an atmospheric atmosphere. Further, as a contrivance other than the calcination, the following measure is conceivable: the area of fourth portion 1d of two-dimensional material layer 1 is made equal to or larger than the area of third portion 1c when viewed in a plan view, thereby suppressing detachment of two-dimensional material layer 1 at the time of forming the opening of semiconductor layer 4.

### Principle of Operation of Electromagnetic Wave Detector

Next, a principle of operation of the electromagnetic wave detector according to the present embodiment will be described.

Electromagnetic wave detector 100 functions as a field effect transistor in which each of fourth portion 1d and third portion 1c of two-dimensional material layer 1 serves as a transistor channel, ferroelectric layer 5 serves as a gate, each of first electrode portion 2a and first portion 1a of two-dimensional material layer 1 serves as a source, and each of second electrode portion 2b and second portion 1b of two-dimensional material layer 1 serves as a drain.

As shown in FIG. 2, a power supply circuit to apply voltage V is electrically connected between first electrode portion 2a and second electrode portion 2b, and first electrode portion 2a, two-dimensional material layer 1, semiconductor layer 4, and second electrode portion 2b are electrically connected in this order. Next, voltage V is applied between first electrode portion 2a and second electrode portion 2b. Preferably, voltage V is set to be reverse bias with respect to the Schottky junction between two-dimensional material layer 1 and semiconductor layer 4. When voltage V is applied, current I flows through two-dimensional material layer 1, which is a portion of a current path between first electrode portion 2a and second electrode portion 2b. An ammeter (not shown) is installed in the power supply circuit and current I flowing through two-dimensional material layer 1 is monitored by the ammeter.

In electromagnetic wave detector 100, it is possible to measure, as electromagnetic wave detection signals, a change in electric property caused by absorption of the electromagnetic wave in two-dimensional material layer 1 when the electromagnetic wave is applied, a change in electric property caused by a change in energy barrier at the junction between two-dimensional material layer 1 and semiconductor layer 4, and a change in electric property caused in two-dimensional material layer 1 due to the pyroelectric effect and inverse piezoelectric effect of ferroelectric layer 5.

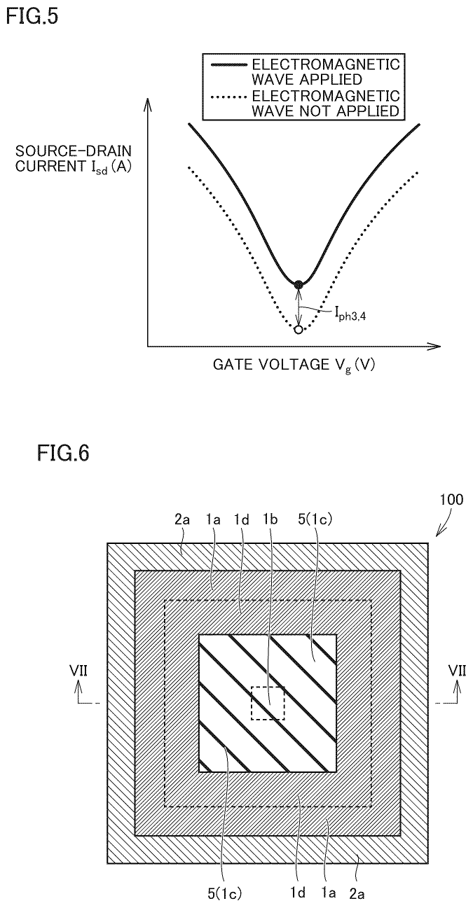

FIG. 4 is a schematic diagram for illustrating the change in electric property caused in two-dimensional material layer 1 by the pyroelectric effect of ferroelectric layer 5, and specifically, is a schematic diagram for illustrating a change in each of gate voltage and source-drain current value in third portion 1c of two-dimensional material layer 1 between a case where the electromagnetic wave is applied and a case where no electromagnetic wave is applied. FIG. 5 is a schematic diagram for illustrating the change in electric property caused in two-dimensional material layer 1 by each of the pyroelectric effect and the inverse piezoelectric effect of ferroelectric layer 5. FIG. 5 shows a change in source-drain current value in response to a change in resistance of third portion 1c of two-dimensional material layer 1 between the case where the electromagnetic wave is applied and the case where no electromagnetic wave is applied, and shows gate voltage dependency.

Regarding the response to the pyroelectric effect of ferroelectric layer 5 shown in FIG. 4, when the electromagnetic wave is applied to ferroelectric layer 5, dielectric polarization is changed inside ferroelectric layer 5 due to the pyroelectric effect of ferroelectric layer 5.

The change in polarization in ferroelectric layer 5 due to the pyroelectric effect provides an electric field change to third portion 1c of two-dimensional material layer 1. As a result, gate voltage Vph is applied to third portion 1c of two-dimensional material layer 1, thereby changing the source-drain current value in third portion 1c of two-dimensional material layer 1. By detecting this current change amount Iph1, the electromagnetic wave applied to electromagnetic wave detector 100 can be detected. Hereinafter, a photogating effect is defined as such an effect that the electric field effect is applied to two-dimensional material layer 1 by the change in electric property of the material in contact with two-dimensional material layer 1 so as to change the electric property of two-dimensional material layer 1 as described above. In fourth portion 1d of two-dimensional material layer 1, the photogating effect is caused by photo carriers generated in a depletion layer formed between semiconductor layer 4 and insulating layer 3 in response to the application of electromagnetic wave.

When the electromagnetic wave for which semiconductor layer 4 has sensitivity is applied to semiconductor layer 4, the source-drain current value in fourth portion 1d of two-dimensional material layer 1 is changed. By detecting this current change amount Iph2, the electromagnetic wave applied to the electromagnetic wave detector can be detected. It should be noted that in FIG. 4, as a schematic diagram, current change amount Iph1 and current change amount Iph2 are shown to be the same, but the current change amounts may be different from each other.

Here, the photogating effect is caused in ferroelectric layer 5 in response to the pyroelectric effect regardless of the direction of the dielectric polarization in ferroelectric layer 5. On the other hand, a degree of the photogating effect in response to the pyroelectric effect (amount of change in electric property of two-dimensional material layer 1) is changed in the two-dimensional plane of third portion 1c of two-dimensional material layer 1 except for a case where the dielectric polarization direction in ferroelectric layer 5 is completely orthogonal to the two-dimensional plane of third portion 1c of two-dimensional material layer 1.

A voltage change in the two-dimensional plane of third portion 1c of two-dimensional material layer 1 by the photogating effect caused in response to the pyroelectric effect of ferroelectric layer 5 contributes as a change in the source-drain voltage, thereby changing the current value. By detecting this current change amount Iph3, the electromagnetic wave applied to the electromagnetic wave detector can be detected.

Regarding the response to the inverse piezoelectric effect of ferroelectric layer 5, when the electromagnetic wave is applied to ferroelectric layer 5 to cause a change in dielectric polarization in ferroelectric layer 5, force is applied to ferroelectric layer 5 by the inverse piezoelectric effect. When ferroelectric layer 5 is deformed by the inverse piezoelectric effect, two-dimensional material layer 1 connected to ferroelectric layer 5 is also deformed. An amount of deformation of two-dimensional material layer 1 is the same as an amount of deformation of ferroelectric layer 5. As a result, the electric resistance value of two-dimensional material layer 1 is changed, thereby changing the source-drain current value in third portion 1c of two-dimensional material layer 1. In other words, in response to the inverse piezoelectric effect in ferroelectric layer 5, the source-drain voltage is applied in two-dimensional material layer 1 in the pseudo manner, thereby changing the current value. By detecting this current change amount Iph4, the electromagnetic wave applied to electromagnetic wave detector 100 can be detected. It should be noted that in FIG. 5, as a schematic diagram, current change amount Iph3 and current change amount Iph4 are shown to be the same, but the current change amounts may be different from each other.

As described above, current change amounts Iph1, Iph2, Iph3, and Iph4 caused by the photogating effect and the source-drain voltage modulation caused in two-dimensional material layer 1 in response to the change in electric property of each of semiconductor layer 4 and ferroelectric layer 5 due to the application of electromagnetic wave are measured as the detection signals.

Further, for example, when semiconductor layer 4 constituting semiconductor layer 4 is composed of p type material silicon and two-dimensional material layer 1 is composed of n type material graphene, fourth portion 1d of two-dimensional material layer 1 and semiconductor layer 4 are in Schottky junction with each other. On this occasion, by adjusting voltage V to apply reverse bias to the Schottky junction, current I can be zero. When the electromagnetic wave is applied to ferroelectric layer 5, the dielectric polarization of ferroelectric layer 5 is changed by the pyroelectric effect to modulate the Fermi level of two-dimensional material layer 1, thus resulting in decreased energy barrier between two-dimensional material layer 1 and semiconductor layer 4. As a result, current flows through semiconductor layer 4 only when the electromagnetic wave is applied, and current I is detected. That is, the electromagnetic wave detector according to the present embodiment can be turned off.

Here, electromagnetic wave detector 100 according to the present embodiment is not limited to the configuration for detecting the change in current in two-dimensional material layer 1 as described above, and electromagnetic wave detector 100 according to the present embodiment may be provided to detect a change in voltage V between first electrode portion 2a and second electrode portion 2b (i.e., a change in voltage value in two-dimensional material layer 1) by causing certain current to flow between first electrode portion 2a and second electrode portion 2b, for example.

Further, electromagnetic wave detector 100 may be provided to detect a change in frequency of the value of current flowing through third portion 1c between the case where no electromagnetic wave is applied and the case where the electromagnetic wave is applied. An electric resonance frequency of third portion 1c of two-dimensional material layer 1 depends on an amount of light of the applied electromagnetic wave, and depends on the amount of deformation in response to the inverse piezoelectric effect of ferroelectric layer 5 and the temperature change of two-dimensional material layer 1. Therefore, the electromagnetic wave may be detected by converting the amount of change in the resonance frequency in third portion 1c into the amount of light of the electromagnetic wave under application of DC voltage between first electrode portion 2a and second electrode portion 2b.

Further, two or more electromagnetic wave detectors 100 may be used to detect the electromagnetic wave. For example, two or more same electromagnetic wave detectors 100 are prepared. One electromagnetic wave detector 100 is disposed in a shielded space to which no electromagnetic wave is applied. The other electromagnetic wave detector 100 is disposed in a measurement target space to which the electromagnetic wave is applied. Then, a difference is detected between current I or voltage V of the other electromagnetic wave detector 100 to which the electromagnetic wave is applied and current I or voltage V of electromagnetic wave detector 100 disposed in the shielded space. In this way, the electromagnetic wave may be detected.

### Operation of Electromagnetic Wave Detector

Next, a specific operation of electromagnetic wave detector 100 shown in FIGS. 1 and 2 will be described. Here, the following describes a case where the single-layer graphene is used as two-dimensional material layer 1, chromium/gold formed by sputtering film formation is used as each of first electrode portion 2a and second electrode portion 2b, silicon oxide is used as insulating layer 3, p type silicon is used as semiconductor layer 4, and lithium niobate formed using an atomic layer deposition method to have a crystal orientation parallel to a plane direction of two-dimensional material layer 1 is used as ferroelectric layer 5.

As shown in FIG. 2, when voltage is applied between the chromium/gold of first electrode portion 2a and the chromium/gold of second electrode portion 2b so as to be reverse bias with respect to the Schottky junction between the single-layer graphene and the p type silicon, a depletion layer is formed in the vicinity of a junction interface between the single-layer graphene and the p type silicon. A range of the detection wavelength in the electromagnetic wave detector is determined in accordance with absorption wavelengths of the lithium niobate and the p type silicon.

When the electromagnetic wave having the detection wavelength enters the lithium niobate, the dielectric polarization is changed in the lithium niobate due to the pyroelectric effect. The change in polarization in the lithium niobate causes a change in electric field in two-dimensional material layer 1. This is the photogating effect described above. As described above, since the graphene, of which two-dimensional material layer 1 is composed, has high mobility, a large amount of displacement current can be obtained in response to a slight change in electric field. Therefore, the Fermi level of two-dimensional material layer 1 is greatly changed by the pyroelectric effect of the lithium niobate, thus resulting in decreased energy barrier with the p type silicon. Thus, charges are injected from the chromium/gold of first electrode portion 2a into the single-layer graphene. Further, the current charges extracted from the p type silicon and injected in response to the application of light are greatly amplified by the photogating effect caused by the pyroelectric effect of the lithium niobate in the single-layer graphene and the source-drain voltage resulting from a distribution of the photogating effect caused in the plane of the single-layer graphene. Therefore, in electromagnetic wave detector 100 according to the present embodiment, high sensitivity exceeding a quantum efficiency of 100% can be achieved.

Further, when a speed of change in dielectric polarization of the lithium niobate is designed to be as short as possible, a period of time from the time of entrance of the electromagnetic wave into the electromagnetic wave detector to the time of occurrence of the change in the resistance value in the single-layer graphene becomes short. According to such an electromagnetic wave detector, delay of the amplification due to the photogating effect is eliminated, thereby increasing the response speed.

### Functions and Effects

Next, functions and effects of the present embodiment will be described.

Electromagnetic wave detector 100 according to the present embodiment includes: two-dimensional material layer 1 having first portion 1a, second portion 1b, and third portion 1c, second portion 1b being disposed with a space being interposed between first portion 1a and second portion 1b in first direction X, third portion 1c being bridged between first portion 1a and second portion 1b in first direction X; first electrode portion 2a electrically connected to first portion la; and second electrode portion 2b electrically connected to first electrode portion 2a via first portion 1a, third portion 1c, and second portion 1b of two-dimensional material layer 1; and ferroelectric layer 5 at least having a portion disposed on third portion 1c.

In electromagnetic wave detector 100, when the dielectric polarization in ferroelectric layer 5 is changed due to the pyroelectric effect, the resistance value of two-dimensional material layer 1 can be changed. As a result, the electric conductivity of two-dimensional material layer 1 is modulated, with the result that the photocurrent can be amplified in two-dimensional material layer 1.

The current change amount in two-dimensional material layer 1 due to the change in polarization in ferroelectric layer 5 is larger than a current change amount in an ordinary semiconductor. In particular, in two-dimensional material layer 1, a great current change occurs in response to a slight potential change as compared with the ordinary semiconductor. For example, when the single-layer graphene is used as two-dimensional material layer 1, the thickness of two-dimensional material layer 1 corresponds to the thickness of one atomic layer and is therefore very thin. Further, the mobility of electrons in the single-layer graphene is high. In this case, the current change amount in two-dimensional material layer 1 as calculated from the mobility of electrons in two-dimensional material layer 1 and the thickness thereof is several hundred times to several thousand times as large as the current change amount in the ordinary semiconductor.

Therefore, by utilizing the photogating effect, efficiency of extracting the detection current in two-dimensional material layer 1 is significantly improved. Such a photogating effect does not directly increase the quantum efficiency of the photoelectric conversion material such as the ordinary semiconductor, but increases the change in current due to the entrance of electromagnetic wave. Therefore, the quantum efficiency of the electromagnetic wave detector as calculated equivalently from the differential current resulting from the entrance of the electromagnetic wave can exceed 100%. Therefore, the detection sensitivity of electromagnetic wave detector 100 according to the present embodiment for the electromagnetic wave is higher than that of the conventional semiconductor electromagnetic wave detector or the graphene electromagnetic wave detector to which the photogating effect is not applied.

Further, in electromagnetic wave detector 100, the thermal capacity of the electromagnetic wave detection portion is smaller, the time required to reach thermal equilibrium is shorter, and the response speed is higher than those in the conventional semiconductor electromagnetic wave detector. In electromagnetic wave detector 100, in addition to the quantum operation for detecting photoelectron positive hole pairs in semiconductor layer 4 and the Schottky junction formed between semiconductor layer 4 and two-dimensional material layer 1, the thermal operation for detecting the temperature change in response to the application of electromagnetic wave is used as a principle of response. The carrier mobility of the material of the detection portion predominantly determines the response speed in the quantum operation. As compared with the conventional bulk semiconductor material, two-dimensional material layer 1 has high carrier mobility resulting from its atomic layer structure, so that the response speed is high in the quantum operation. In addition, since the response speed of the thermal operation is in a trade-off relation with the thermal capacity of the electromagnetic wave detection portion, the response speed can be improved by reducing the thermal capacity. Third portion 1c of two-dimensional material layer 1 provided as the detection region for the electromagnetic wave has the bridged structure, and is thermally independent of and thermally insulated from semiconductor layer 4 and the like. Two-dimensional material layer 1 has the single-atomic-layer structure and has a thermal capacity ultimately smaller than that of the conventional bulk semiconductor material. Therefore, the detection speed of electromagnetic wave detector 100 according to the present embodiment for the electromagnetic wave is higher than that of the conventional electromagnetic wave detector that employs the thermal operation.

Electromagnetic wave detector 100 according to the present embodiment further includes insulating layer 3 disposed on first region 41a of semiconductor layer 4, second region 41b and third region 41c being exposed from insulating layer 3. Second portion 1b of two-dimensional material layer 1 is in contact with, preferably in Schottky junction with, second region 41b of semiconductor layer 4. Third portion 1c of two-dimensional material layer 1 is disposed with a space being interposed between third portion 1c and third region 41c in a direction orthogonal to first surface 41.

In the case where two-dimensional material layer 1 and semiconductor layer 4 are in Schottky junction with each other, when reverse bias is applied to the Schottky junction, no current flows, with the result that electromagnetic wave detector 100 can be turned off. In addition, except for a case where the dielectric polarization direction in ferroelectric layer 5 is completely orthogonal to the two-dimensional plane of third portion 1c of two-dimensional material layer 1, the photogating effect in response to the pyroelectric effect is changed in the two-dimensional plane of third portion 1c of two-dimensional material layer 1 to change the source-drain voltage. By adjusting voltage V to avoid flow of current in a state in which no electromagnetic wave is applied and the source-drain voltage is not changed, electromagnetic wave detector 100 can be turned off.

Further, since two-dimensional material layer 1 has fourth portion 1d disposed on insulating layer 3 in electromagnetic wave detector 100 according to the present embodiment, the electric conductivity of two-dimensional material layer 1 is more likely to be modulated by the photogating effect than in the case where two-dimensional material layer 1 does not have fourth portion 1d.

Further, the amount of change in current value I when the electromagnetic wave is applied to electromagnetic wave detector 100 according to the present embodiment includes: the amount of change in current caused by the change in the resistance value of two-dimensional material layer 1 due to the pyroelectric effect in ferroelectric layer 5; the amount of change in the current caused by the change in energy barrier between two-dimensional material layer 1 and semiconductor layer 4; and the amount of photocurrent caused by photoelectric conversion in two-dimensional material layer 1. In other words, in response to the entrance of electromagnetic wave, the electromagnetic wave detector according to the present embodiment can detect a change in each of current generated by the above-described photogating effect, current due to an energy barrier change, and a photocurrent due to the photoelectric conversion efficiency inherent in two-dimensional material layer 1.

As described above, electromagnetic wave detector 100 according to the present embodiment can realize improved sensitivity with a quantum efficiency of 100% or more, can realize a high-speed operation, and can be turned off.

Further, in electromagnetic wave detector 100 according to the present embodiment, when the material of semiconductor layer 4 includes silicon, a reading circuit can be formed in semiconductor layer 4. This makes it possible to read a signal without requiring to form a circuit outside the element.

### Modification

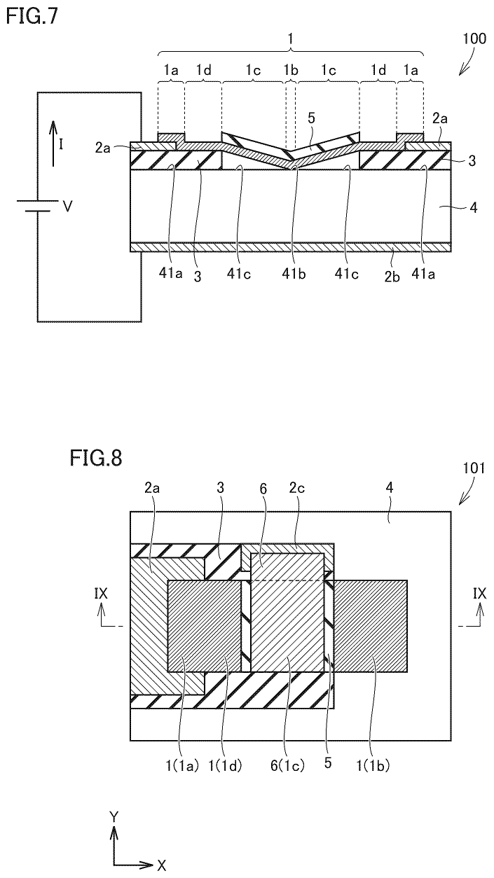

FIG. 6 is a top view showing a first modification of electromagnetic wave detector 100 according to the first embodiment. FIG. 7 is a schematic cross sectional view showing the first modification of the electromagnetic wave detector according to the first embodiment.

As shown in FIGS. 6 and 7, in electromagnetic wave detector 100, each of two-dimensional material layer 1, first electrode portion 2a, insulating layer 3, semiconductor layer 4, and ferroelectric layer 5 may have symmetry with respect to second portion 1b when viewed in a plan view. In other words, electromagnetic wave detector 100 may include a plurality of element structures having symmetry with respect to one another.

In this case, since second portion 1b of two-dimensional material layer 1 and second region 41b of semiconductor layer 4 in contact with second portion 1b can be integrated between the plurality of element structures having symmetry with respect to one another, the structure can be simplified as compared with a case where the plurality of element structures are formed independently of one another. As a result, the number of manufacturing processes for electromagnetic wave detector 100 can be reduced and yield can be improved.

Also in this case, since stress applied to third portion 1c of two-dimensional material layer 1 can be evenly distributed among the plurality of element structures having symmetry with respect to one another, two-dimensional material layer 1 can be suppressed from being detached or broken due to concentration or unevenness of stress concentration in third portion 1c. As a result, yield and reliability of electromagnetic wave detector 100 can be improved.

For example, each of two-dimensional material layer 1, first electrode portion 2a, insulating layer 3, semiconductor layer 4, and ferroelectric layer 5 may have four-fold rotational symmetry in a peripheral direction around second portion 1b when viewed in a plan view.

### Second Embodiment

### Configuration of Electromagnetic Wave Detector

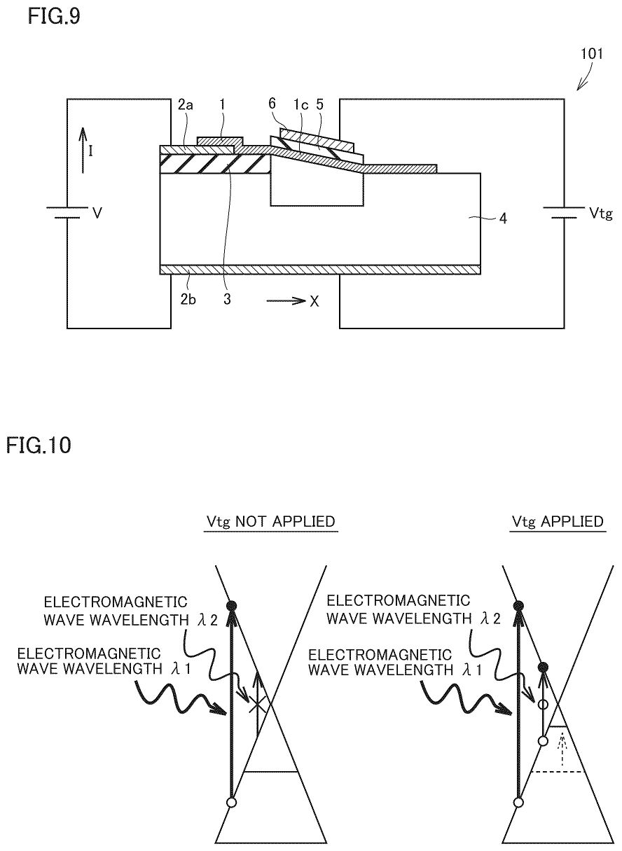

FIG. 8 is a schematic plan view of an electromagnetic wave detector according to a second embodiment. FIG. 9 is a schematic cross sectional view along a line segment IX-IX in FIG. 8.

The electromagnetic wave detector shown in FIG. 8 basically has the same configuration and the same effect as those of the electromagnetic wave detector shown in FIGS. 1 and 2, but is different from electromagnetic wave detector 100 shown in FIGS. 1 and 2 in that the electromagnetic wave detector shown in FIG. 8 further includes a second two-dimensional material layer 6 and a third electrode portion 2c (see FIG. 8). The following mainly describes the difference between an electromagnetic wave detector 101 and electromagnetic wave detector 100.

As shown in FIG. 8, third electrode portion 2c is disposed with a space being interposed between third electrode portion 2c and third portion 1c of two-dimensional material layer 1 in second direction Y when viewed in a plan view. Third electrode portion 2c is disposed on insulating layer 3.

A portion of second two-dimensional material layer 6 is disposed on ferroelectric layer 5. The portion of second two-dimensional material layer 6 and third portion 1c of two-dimensional material layer 1 are disposed to sandwich ferroelectric layer 5.

A remainder of second two-dimensional material layer 6 extends along second direction Y from the portion of second two-dimensional material layer 6 disposed on ferroelectric layer 5. The remainder of second two-dimensional material layer 6 is disposed on insulating layer 3. A portion of the remainder of second two-dimensional material layer 6 is electrically connected to third electrode portion 2c. The portion of the remainder of second two-dimensional material layer 6 is disposed on third electrode portion 2c.

The material of second two-dimensional material layer 6 can be selected in the same manner as the material of two-dimensional material layer 1. The material of second two-dimensional material layer 6 includes, for example, at least one selected from a group consisting of graphene, transition metal dichalcogenide, black phosphorus, silicene, and germanene. The material of second two-dimensional material layer 6 is, for example, the same as the material of two-dimensional material layer 1, and is graphene as one example.

Third electrode portion 2c is provided to modulate the Fermi level of third portion 1c by applying voltage Vtg to third portion 1c of two-dimensional material layer 1 through second two-dimensional material layer 6. <Principle of Operation of Electromagnetic Wave Detector>

Next, a principle of operation of electromagnetic wave detector 101 according to the present embodiment will be described.

As shown in FIG. 8, electromagnetic wave detector 101 according to the present embodiment basically has the same electric connection as that of electromagnetic wave detector 100 shown in FIG. 2, and third electrode portion 2c, second two-dimensional material layer 6, and ferroelectric layer 5 are further electrically connected in this order. Next, voltage V is applied between first electrode portion 2a and second electrode portion 2b, and voltage Vtg is applied from third electrode portion 2c to ferroelectric layer 5.

Electromagnetic wave detector 101 according to the present embodiment functions as a field effect transistor in which each of fourth portion 1d and third portion 1c of two-dimensional material layer 1 serves as a transistor channel, second two-dimensional material layer 6 serves as a second gate, ferroelectric layer 5 serves as a first gate, each of first electrode portion 2a and first portion 1a of two-dimensional material layer 1 serves as a source, and each of second electrode portion 2b and second portion 1b of two-dimensional material layer 1 serves as a drain. Voltage Vtg is applied from third electrode portion 2c to ferroelectric layer 5 via second two-dimensional material layer 6, and causes a piezoelectric effect in ferroelectric layer 5.

Further, voltage Vtg functions as a gate voltage for modulating a surface charge density with ferroelectric layer 5 and third portion 1c of two-dimensional material layer 1 each serving as a channel.

### Functions and Effects

In electromagnetic wave detector 101 according to the present embodiment, an electromagnetic wave absorption ratio and detection sensitivity of two-dimensional material layer 1 can be adjusted. By applying voltage Vtg from third electrode portion 2c to ferroelectric layer 5, an electric field effect is generated, thereby modulating the Fermi level of third portion 1c of two-dimensional material layer 1.

FIG. 10 is a schematic diagram showing a band structure and a Fermi level change in third portion 1c when graphene is used for two-dimensional material layer 1. The graphene has a zero-bandgap structure in which a conduction band and a valence band are combined, and a course of excitation of photo carriers in response to application of electromagnetic wave is different from that in a conventional semiconductor material. That is, in order to excite the photo carriers in the graphene in response to inter-band transition between the conduction band and the valence band of the graphene, the Fermi level of the graphene needs to reach an energy level corresponding to the wavelength of the electromagnetic wave. When the Fermi level of the graphene is insufficient as compared with the energy level corresponding to the detection wavelength, even though an electromagnetic wave enters electromagnetic wave detector 101, photo carriers are not excited in the graphene. The left-hand portion of FIG. 10 shows that the photo carriers are not excited in the graphene even when an electromagnetic wave having a wavelength 22 (low energy) that is longer than a wavelength 21 of the electromagnetic wave having energy required to excite photo carriers in the graphene enters electromagnetic wave detector 101. On the other hand, in electromagnetic wave detector 101, the Fermi level of the graphene can be modulated by applying top gate voltage Vtg. Specifically, the energy required to excite photo carriers in the graphene to which voltage Vtg is applied can be smaller than the energy required to excite photo carriers in the graphene to which voltage Vtg is not applied. As a result, as shown in the right-hand portion of FIG. 10, when the electromagnetic wave having wavelength 22 enters electromagnetic wave detector 101 under application of voltage Vtg, photo carriers can be excited in the graphene. That is, by adjusting top gate voltage Vtg, the wavelength of the electromagnetic wave by which the photo carriers can be excited in the graphene can be changed. Therefore, in electromagnetic wave detector 101, high sensitivity can be realized, and absorption and excitation of an electromagnetic wave in a wavelength range not desired to be detected can be prevented to improve spectral performance.

Also in electromagnetic wave detector 101, the electric resonance frequency of third portion 1c of two-dimensional material layer 1 depends on the amount of light of applied electromagnetic wave. By applying, to third portion 1c as voltage Vtg, a signal having the same frequency as the resonance frequency of third portion 1c when an electromagnetic wave with an amount of light to be detected enters electromagnetic wave detector 101, only absorption of an electromagnetic wave with a specific amount of light can be detected through resonance. That is, the amount of light that can be detected by electromagnetic wave detector 101 can be adjusted by changing the frequency of voltage Vtg. That is, by changing the frequency of voltage Vtg, the detection sensitivity of electromagnetic wave detector 101 can be adjusted, thereby improving dynamic range of electromagnetic wave detector 101.

Here, the configuration of the electromagnetic wave detector according to the present embodiment can also be applied to other embodiments.

### Third Embodiment

### Configuration of Electromagnetic Wave Detector

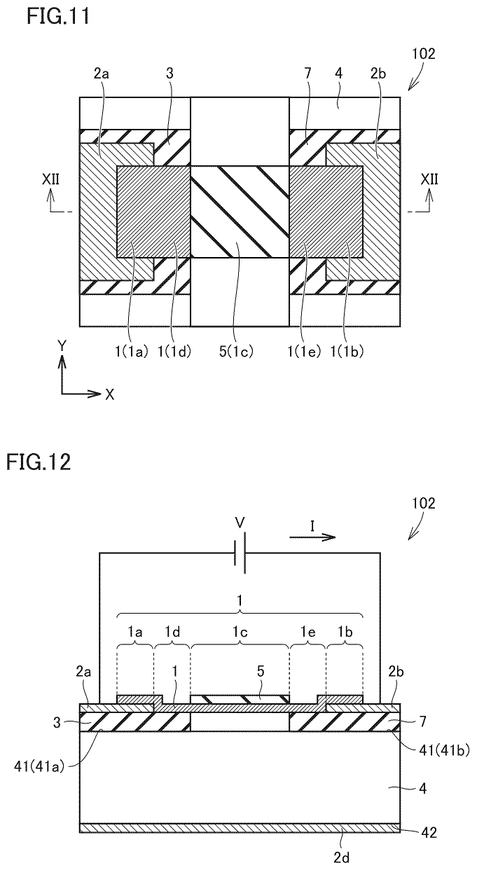

FIG. 11 is a schematic plan view of an electromagnetic wave detector 102 according to a third embodiment. FIG. 12 is a schematic cross sectional view along a line segment XII-XII of FIG. 11.

Electromagnetic wave detector 102 shown in FIGS. 11 and 12 basically has the same configuration and the same effect as those of electromagnetic wave detector 100 shown in FIGS. 1 and 2, but is different from electromagnetic wave detector 100 shown in FIGS. 1 and 2 in that two-dimensional material layer 1 is not electrically connected to semiconductor layer 4. The following mainly describes the difference between electromagnetic wave detector 102 and electromagnetic wave detector 100.

Electromagnetic wave detector 102 further includes a second insulating layer 7 disposed on second region 41b of first surface 41 of semiconductor layer 4. Second insulating layer 7 is disposed to separate insulating layer 3 and third region 41c from each other in first direction X. Second electrode portion 2b is disposed on second insulating layer 7. Second electrode portion 2b is not electrically connected to semiconductor layer 4. The thickness of second insulating layer 7 is equal to the thickness of insulating layer 3, for example. Second insulating layer 7 is manufactured by the same manufacturing process as the manufacturing process for insulating layer 3, for example.

Second portion 1b of two-dimensional material layer 1 is disposed on second insulating layer 7. Second portion 1b is electrically connected to second electrode portion 2b on second insulating layer 7. Second portion 1b is in contact with second electrode portion 2b.

Two-dimensional material layer 1 further includes a fifth portion 1e disposed on second insulating layer 7. Fifth portion 1e connects between third portion 1c and second portion 1b. First portion 1a, fourth portion 1d, third portion 1c, fifth portion le, and second portion 1b are connected in first direction X in this order. Fifth portion le is in contact with the upper surface of second insulating layer 7.

Electromagnetic wave detector 102 may further include a fourth electrode portion 2d disposed on second surface 42 of semiconductor layer 4.

### Principle of Operation of Electromagnetic Wave Detector

Next, a principle of operation of electromagnetic wave detector 102 according to the present embodiment will be described.

As shown in FIG. 12, in electromagnetic wave detector 102, first electrode portion 2a, first portion 1a, fourth portion 1d, third portion 1c, fifth portion le, second portion 1b of two-dimensional material layer 1, and second electrode portion 2b are electrically connected in this order. Next, voltage V is applied between first electrode portion 2a and second electrode portion 2b. Current I flows through two-dimensional material layer 1 serving as a portion of the current path between first electrode portion 2a and second electrode portion 2b. An ammeter (not shown) is installed in a power supply circuit, and current I flowing through two-dimensional material layer 1 is monitored by the ammeter.

### Functions and Effects

As described above, electromagnetic wave detector 102 according to the present embodiment has the same effect as that of electromagnetic wave detector 100. In electromagnetic wave detector 102, two-dimensional material layer 1 is not in Schottky junction with semiconductor layer 4. However, also in electromagnetic wave detector 102, the photogating effect in response to the pyroelectric effect is changed in the two-dimensional plane of third portion 1c of two-dimensional material layer 1 to change the source-drain voltage except for a case where the dielectric polarization direction in ferroelectric layer 5 is completely orthogonal to the two-dimensional plane of third portion 1c of two-dimensional material layer 1. As a result, by adjusting voltage V such that no current flows in a state in which no electromagnetic wave is applied and the source-drain voltage is not changed, electromagnetic wave detector 102 can also be turned off.

Here, the configuration of the electromagnetic wave detector according to the present embodiment can also be applied to other embodiments.

### Fourth Embodiment.

### Configuration of Electromagnetic Wave Detector

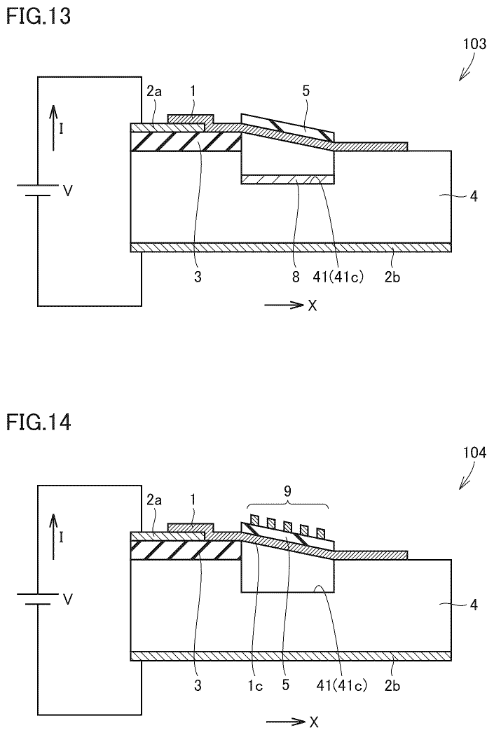

FIG. 13 is a schematic cross sectional view of an electromagnetic wave detector 103 according to a fourth embodiment. A schematic plan view thereof is the same as FIG. 1.

Electromagnetic wave detector 103 shown in FIG. 13 basically has the same configuration and the same effect as those of electromagnetic wave detector 100 shown in FIGS. 1 and 2, but is different from electromagnetic wave detector 100 shown in FIGS. 1 and 2 in that electromagnetic wave detector 103 has a reflective film 8. The following mainly describes the difference between electromagnetic wave detector 103 and electromagnetic wave detector 100.

As shown in FIG. 13, in electromagnetic wave detector 103, reflective film 8 is disposed on semiconductor layer 4 located below third portion 1c of two-dimensional material layer 1 and ferroelectric layer 5. For a material of reflective film 8, any material can be used as long as it has a reflective property in a wavelength range of an electromagnetic wave to be absorbed in each of two-dimensional material layer 1 and ferroelectric layer 5. For example, the material of reflective film 8 includes at least one selected from a group consisting of gold (Au), silver (Ag), copper (Cu), aluminum (Al), nickel (Ni), chromium (Cr), and palladium (Pd).

Reflective film 8 is disposed on third region 41c of first surface 41 of semiconductor layer 4. Reflective film 8 is disposed with a space being interposed between reflective film 8 and each of third portion 1c of two-dimensional material layer 1 and ferroelectric layer 5 in the direction orthogonal to third region 41c of first surface 41. Reflective film 8 is provided not to prevent deformation of third portion 1c of two-dimensional material layer 1. Reflective film 8 is in contact with, for example, third region 41c, which is the bottom surface of recess 43.

The planar shape of reflective film 8 may be any shape, such as a circular shape, a triangular shape, a quadrangular shape, a polygonal shape, or an elliptical shape.

A method of forming reflective film 8 may be any method, and may be the same as, for example, the method of forming first electrode portion 2a in the method of manufacturing electromagnetic wave detector 100 according to the first embodiment.

Preferably, the space between reflective film 8 and third portion 1c of two-dimensional material layer 1 in the direction orthogonal to third region 41c is set to ¼ of the detection wavelength. Since the space between reflective film 8 and third portion 1c of two-dimensional material layer 1 is set to ¼ of the detection wavelength, interference resonance occurs between the electromagnetic wave entering reflective film 8 and the electromagnetic wave reflected from reflective film 8, thus resulting in an increased absorption coefficient as compared with a case where the space is not set to ¼ of the detection wavelength.

### Functions and Effects

Since electromagnetic wave detector 103 further includes reflective film 8, the electromagnetic wave having passed through ferroelectric layer 5 and third portion 1c of two-dimensional material layer 1 in the electromagnetic wave applied to electromagnetic wave detector 103 can be reflected by reflective film 8 and can re-enter each of third portion 1c of two-dimensional material layer 1 and ferroelectric layer 5.

As a result, each of third portion 1c of two-dimensional material layer 1 and ferroelectric layer 5 is facilitated to absorb the electromagnetic wave, thus resulting in high detection sensitivity of electromagnetic wave detector 103. Further, in electromagnetic wave detector 103 in which the space between reflective film 8 and third portion 1c of two-dimensional material layer 1 is set to ¼ of the detection wavelength, the entered light and the reflected light interfere and resonate with each other as described above, with the result that the absorption coefficient and the detection sensitivity are higher than those of electromagnetic wave detector 103 in which the space is not set to ¼ of the detection wavelength.

Here, the configuration of the electromagnetic wave detector according to the present embodiment can also be applied to other embodiments.

### Fifth Embodiment

### Configuration of Electromagnetic Wave Detector

FIG. 14 is a schematic cross sectional view of an electromagnetic wave detector 104 according to a fifth embodiment. A schematic plan view thereof is the same as FIG. 1.

Electromagnetic wave detector 104 according to the fifth embodiment basically has the same configuration and the same effect as those of electromagnetic wave detector 100 shown in FIGS. 1 and 2, but is different from electromagnetic wave detector 100 shown in FIGS. 1 and 2 in that electromagnetic wave detector 104 further includes one or more conductors 9 in contact with at least one of third portion 1c of two-dimensional material layer 1 and ferroelectric layer 5. The following mainly describes the difference between electromagnetic wave detector 104 and electromagnetic wave detector 100.

In electromagnetic wave detector 104 shown in FIG. 14, a plurality of conductors 9 are in contact with ferroelectric layer 5. The plurality of conductors 9 are disposed on third portion 1c with a space being interposed therebetween in first direction X.

The plurality of conductors 9 have, for example, a one-dimensional periodic structure. The arrangement of the plurality of conductors 9 when viewed in a plan view has periodic symmetry, for example. The plurality of conductors 9 are arranged periodically in one dimension in first direction X, for example. It should be noted that the plurality of conductors 9 may be arranged periodically in one dimension in second direction Y (depth direction in the plane of sheet of FIG. 14).

Further, the plurality of conductors 9 may have a two-dimensional periodic structure. For example, when viewed in a plan view of the electromagnetic wave detector, each of the plurality of conductors 9 may be arranged at a position corresponding to a lattice point of a square lattice or a triangular lattice.

Further, the plurality of conductors 9 may be arranged non-periodically. The arrangement of the plurality of conductors 9 when viewed in a plan view may have asymmetry.

The shapes and sizes of the plurality of conductors 9 are the same, for example. It should be noted that the shapes and sizes of the plurality of conductors 9 may be different from one another.

Each of the plurality of conductors 9 is a floating electrode. Each of the plurality of conductors 9 is not connected to a power supply circuit or the like, and is therefore floating.

The material of conductor 9 may be any material as long as it has electric conductivity. The material of conductor 9 includes, for example, at least one selected from a group consisting of gold (Au), silver (Ag), copper (Cu), aluminum (Al), nickel (Ni), chromium (Cr), and palladium (Pd). Preferably, the material of conductor 9 is a material that causes surface plasmon resonance in conductor 9.

The planar shape of each of the plurality of conductors 9 may be any shape, such as a circular shape, a triangular shape, a quadrangular shape, a polygonal shape, or an elliptical shape.

The method of forming each of the plurality of conductors 9 may be any method, and may be the same as, for example, the method of forming first electrode portion 2a in the method of manufacturing electromagnetic wave detector 100 according to the first embodiment.

### Functions and Effects

Since electromagnetic wave detector 104 further includes conductors 9 each serving as a floating electrode on two-dimensional material layer 1, surface carriers generated in ferroelectric layer 5 by application of electromagnetic wave can be moved between the plurality of conductors 9. As a result, in electromagnetic wave detector 104, the life of each of the photo carriers becomes long, thus resulting in increased detection sensitivity.

Further, when the plurality of conductors 9 have a one-dimensional periodic structure and the material of each of conductors 9 is a material that causes surface plasmon resonance, polarization dependency on the applied electromagnetic wave is caused in conductor 9. As a result, only an electromagnetic wave having specific polarization is applied to semiconductor layer 4 of electromagnetic wave detector 104, with the result that electromagnetic wave detector 104 can detect only the specific polarization with high sensitivity.

Further, when the plurality of conductors 9 have a two-dimensional periodic structure and the material of each of conductors 9 is a material that causes surface plasmon resonance, the electromagnetic wave having the specific wavelength is resonated by the plurality of conductors 9. As a result, only the electromagnetic wave having the specific wavelength is applied to semiconductor layer 4 of electromagnetic wave detector 104, with the result that electromagnetic wave detector 104 can detect only the electromagnetic wave having the specific wavelength with high sensitivity.

Further, when the plurality of conductors 9 are arranged non-periodically when viewed in a plan view, the polarization dependency on the applied electromagnetic wave is caused in conductor 9 in the same manner as in the case where the plurality of conductors 9 have a one-dimensional periodic structure. As a result, only the electromagnetic wave having the specific polarization is applied to semiconductor layer 4 of electromagnetic wave detector 104, with the result that electromagnetic wave detector 104 can detect only the specific polarization with high sensitivity.

Further, in electromagnetic wave detector 104, the plurality of conductors 9 may also be in contact with third portion 1c of two-dimensional material layer 1. The plurality of conductors 9 may not be in contact with ferroelectric layer 5, and may be in contact with third portion 1c of two-dimensional material layer 1. Also with such a configuration, the same effect as that of electromagnetic wave detector 104 shown in FIG. 14 can be obtained.

Further, the plurality of conductors 9 may be disposed below two-dimensional material layer 1, for example. In this case, two-dimensional material layer 1 is not damaged when forming conductors 9, thereby suppressing decreased carrier mobility in two-dimensional material layer 1.

Two-dimensional material layer 1 may have an uneven portion. In this case, the uneven portion of two-dimensional material layer 1 may have a periodic structure or non-periodic structure as with the plurality of conductors 9 described above. Such an uneven portion functions in the same manner as the plurality of conductors 9.

Further, electromagnetic wave detector 104 may include two-dimensional material layer 1 in which the above-mentioned uneven portion is formed instead of the plurality of conductors 9. Also in such an electromagnetic wave detector, since the uneven portion functions in the same manner as the plurality of conductors 9, the same effect as that of electromagnetic wave detector 104 can be obtained.

Here, the configuration of the electromagnetic wave detector according to the present embodiment can also be applied to other embodiments.

### Functions and Effects

Electromagnetic wave detector 104 further includes one or more conductors 9. One or more conductors 9 are disposed in contact with at least one of two-dimensional material layer 1 and ferroelectric layer 5. In this case, the life of each of the photo carriers in two-dimensional material layer 1 becomes long. As a result, the detection sensitivity of electromagnetic wave detector 104 is increased.

### Sixth Embodiment.

### Configuration of Electromagnetic Wave Detector

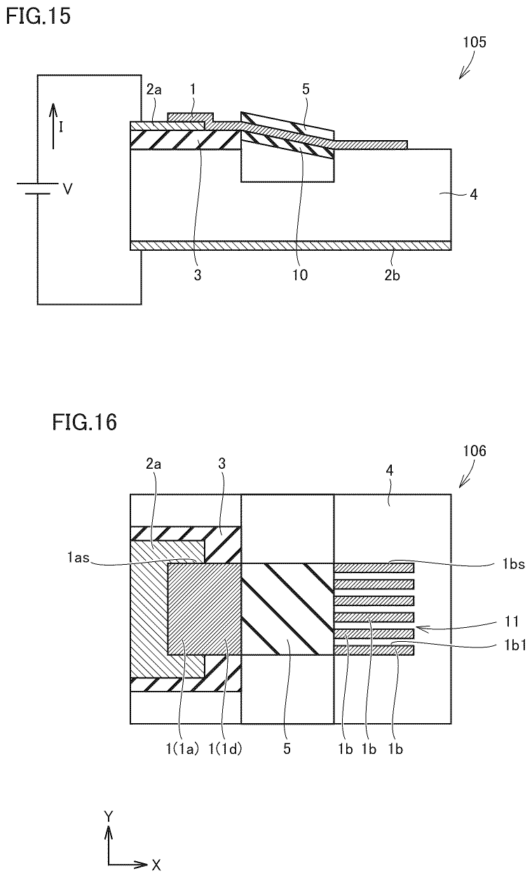

FIG. 15 is a schematic cross sectional view of an electromagnetic wave detector 105 according to a sixth embodiment.

Electromagnetic wave detector 105 shown in FIG. 15 basically has the same configuration and the same effect as those of electromagnetic wave detector 100 shown in FIGS. 1 and 2, but is different from electromagnetic wave detector 100 shown in FIGS. 1 and 2 in that electromagnetic wave detector 105 further includes one or more contact layers 10 in contact with two-dimensional material layer 1. The following mainly describes the difference between electromagnetic wave detector 105 and electromagnetic wave detector 100.

As shown in FIG. 15, a contact layer 10 is in contact with, for example, the lower surface of third portion 1c of two-dimensional material layer 1. Contact layer 10 and ferroelectric layer 5 are disposed to sandwich third portion 1c of two-dimensional material layer 1.

It should be noted that contact layer 10 may be in contact with the upper surface of third portion 1c of two-dimensional material layer 1. In this case, for example, contact layer 10 is arranged side by side with ferroelectric layer 5 in second direction Y (depth direction in the plane of sheet of FIG. 15).

Further, contact layer 10 may be in contact with at least one of second portion 1b, third portion 1c, and fourth portion 1d. Contact layer 10 may be in contact with second portion 1b or fourth portion 1d. Contact layer 10 is provided to dope two-dimensional material layer 1 with electrons or positive holes.

The material of contact layer 10 includes a composition containing: a photosensitive agent having a quinone diazide group and called a positive photoresist; and a novolac resin, for example. The material of contact layer 10 may be a material having a polar group, for example. Specifically, the material of contact layer 10 may be, for example, a material having an electron-attracting group. Such a contact layer 10 has an effect of reducing the electron density of two-dimensional material layer 1. The material of contact layer 10 may be, for example, a material having an electron-donating group. Such a contact layer 10 has an effect of increasing the electron density of two-dimensional material layer 1.

Examples of the material having an electron-attracting group include halogen, nitrile, a material having a carboxyl group, a material having a carbonyl group, and the like. Examples of the material having an electron-donating group include a material having an alkyl group, alcohol, a material having an amino group, a material having a hydroxyl group, and the like. Further, in addition to the materials described above, the material of contact layer 10 may be any material in which imbalance in charges is caused in a whole of molecule by the polar group.

Further, the material of contact layer 10 may be an organic substance, a metal, a semiconductor, an insulator, a two-dimensional material, or a mixture of any of these materials, and may be a material having a polarity due to the imbalance in charges being caused in the molecule. Here, when the material of contact layer 10 is an inorganic substance, the conductivity type in which two-dimensional material layer 1 is doped by contact layer 10 is changed in accordance with a magnitude relation between the work function of contact layer 10 and the work function of two-dimensional material layer 1. When the work function of contact layer 10 is larger than the work function of two-dimensional material layer 1, the conductivity type is p type, whereas when the work function of contact layer 10 is smaller than the work function of two-dimensional material layer 1, the conductivity type is n type. When the material of contact layer 10 is an organic substance, the organic substance, which is the material of contact layer 10, does not have a clear work function, so that the conductivity type in which two-dimensional material layer 1 is doped by contact layer 10 is determined by the polarity of the molecule of the organic substance of contact layer 10.

For example, when the composition that includes the photosensitive agent having a quinone diazide group and called a positive photoresist and the novolac resin is used as contact layer 10, a region of two-dimensional material layer 1 on which a resist is formed by a photolithography process becomes a p type two-dimensional material layer region. This eliminates a need for a process of forming a mask in contact with the surface of two-dimensional material layer 1. As a result, process damage on two-dimensional material layer 1 can be reduced and the process can be simplified.

Preferably, the thickness of contact layer 10 is sufficiently thin to perform photoelectric conversion when an electromagnetic wave is applied to two-dimensional material layer 1. Preferably, the thickness of contact layer 10 is such a thickness that two-dimensional material layer 1 is doped with carriers from contact layer 10.

### Functions and Effects

Electromagnetic wave detector 105 includes contact layer 10 in contact with two-dimensional material layer 1. As described above, since the material having an electron-attracting group or the material having an electron-donating group is used as the material of contact layer 10, the state (conductivity type) of two-dimensional material layer 1 can be intentionally n type or p type. In this case, the carrier doping of two-dimensional material layer 1 can be controlled without considering an influence of carrier doping from first electrode portion 2a and semiconductor layer 4 and the polarization of ferroelectric layer 5. As a result, the performance of the electromagnetic wave detector can be improved.

Further, by forming contact layer 10 only on one of the first electrode portion 2a side or the semiconductor layer 4 side of the upper surface of two-dimensional material layer 1, a gradient of charge density is formed in two-dimensional material layer 1. As a result, the carrier mobility in two-dimensional material layer 1 is improved, thus resulting in high sensitivity of the electromagnetic wave detector.

### Modification

The configuration of contact layer 10 may be appropriately determined as long as photo carriers such as molecules or electrons are supplied to two-dimensional material layer 1. For example, two-dimensional material layer 1 may be immersed in a solution and the photo carriers may be supplied to two-dimensional material layer 1 at a molecular level, with the result that two-dimensional material layer 1 may be doped with the photo carriers without forming contact layer 10 in a solid state on two-dimensional material layer 1.

As the material of contact layer 10, a material that undergoes polarity conversion may be used in addition to the above-described materials. In that case, when contact layer 10 undergoes the polarity conversion, electrons or positive holes generated during the conversion are supplied to two-dimensional material layer 1. Therefore, the portion of two-dimensional material layer 1 in contact with contact layer 10 is doped with the electrons or positive holes. Therefore, even when contact layer 10 is removed, the portion of two-dimensional material layer 1 having been in contact with contact layer 10 remains to be doped with the electrons or positive holes. Therefore, when the material that undergoes polarity conversion is used as contact layer 10, contact layer 10 may be removed from two-dimensional material layer 1 after passage of a certain period of time. In this case, the opening area of two-dimensional material layer 1 is increased as compared with the case where contact layer 10 exists. Therefore, the detection sensitivity of the electromagnetic wave detector can be improved. Here, the polarity conversion is a phenomenon in which the polar group is chemically converted, and means, for example, a phenomenon in which the electron-attracting group is changed to the electron-donating group, the electron-donating group is changed to the electron-attracting group, the polar group is changed to the non-polar group, or the non-polar group is changed to the polar group.

Further, contact layer 10 may be composed of a material that undergoes polarity conversion by application of electromagnetic wave. In this case, by selecting, as the material of contact layer 10, a material that undergoes polarity conversion at a specific wavelength of electromagnetic wave, the polarity conversion is caused in contact layer 10 to dope two-dimensional material layer 1 only when the electromagnetic wave having the specific wavelength is applied. As a result, photocurrent flowing into two-dimensional material layer 1 can be increased.

Further, a material that undergoes an oxidation-reduction reaction by application of electromagnetic wave may be used as the material of contact layer 10. In this case, two-dimensional material layer 1 can be doped with electrons or positive holes generated during the oxidation-reduction reaction.

Further, a plurality of contact layers 10 may be formed on two-dimensional material layer 1. The number of contact layers 10 may be three or more, and can be any number. The plurality of contact layers 10 may be formed on two-dimensional material layer 1 between first electrode portion 2a and semiconductor layer 4. In this case, the plurality of contact layers 10 may be composed of the same material or different materials.

Here, the configuration of the electromagnetic wave detector according to the present embodiment can also be applied to other embodiments.

### Seventh Embodiment.

### Configuration of Electromagnetic Wave Detector

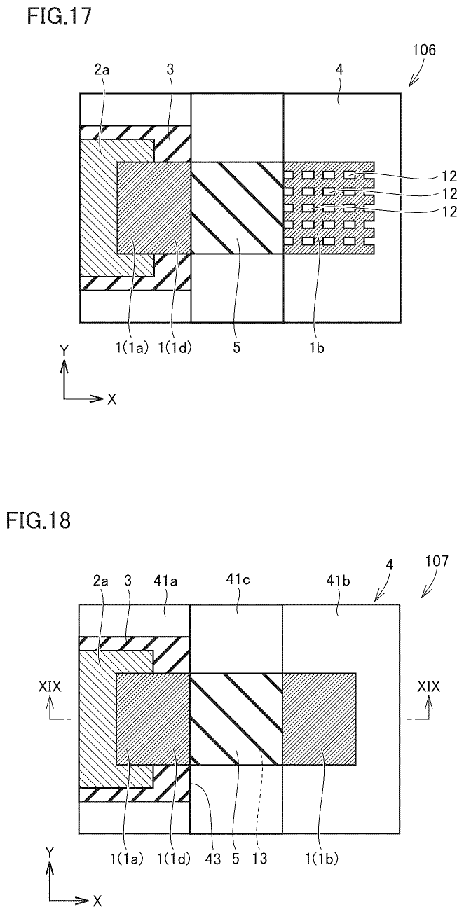

FIG. 16 is a schematic plan view of an electromagnetic wave detector 106 according to a seventh embodiment. FIG. 17 is a schematic plan view showing a first modification of the electromagnetic wave detector according to the seventh embodiment. It should be noted that each of the schematic cross sectional views corresponding to FIGS. 16 and 17 is the same as FIG. 2.

Electromagnetic wave detector 106 shown in FIG. 16 basically has the same configuration and the same effect as those of electromagnetic wave detector 100 shown in FIGS. 1 and 2, but the planar shape of second portion 1b of two-dimensional material layer 1 is different from that of electromagnetic wave detector 100 shown in FIGS. 1 and 2.

First portion 1a of two-dimensional material layer 1 has a first end surface las extending in a direction intersecting first surface 41 of semiconductor layer 4. First end surface las is orthogonal to first surface 41, for example. First end surface las has, for example, a portion oriented in first direction X and a portion oriented in second direction Y.

Second portion 1b of two-dimensional material layer 1 has a second end surfaces 1bs extending in the direction intersecting first surface 41 of semiconductor layer 4. Second end surface 1bs is orthogonal to first surface 41, for example. Second end surface 1bs has, for example, a portion oriented in first direction X and a portion oriented in second direction Y.

The planar shape of second portion 1b is a comb-like shape (ladder-like shape). When viewed in a plan view, at least one slit 11 is formed in second portion 1b. For example, a plurality of slits 11 are formed in second portion 1b. Each of the plurality of slits 11 extends along first direction X, for example. Each of the plurality of slits 11 extends to a boundary between second portion 1b and third portion 1c, for example. Second portion 1b is configured as a collection of a plurality of minute portions arranged with a space being interposed therebetween in second direction Y. An end portion of each of the plurality of minute portions in the first direction is connected to third portion 1c. The planar shape of each of the plurality of minute portions may be any shape, such as a rectangular shape.

Each planar shape of second portion 1b shown in FIG. 16 is symmetrical with respect to a center line that passes through the center of semiconductor layer 4 in first direction X and that extends along second direction Y. The planar shape of second portion 1b shown in FIG. 16 is symmetrical with respect to a center line that passes through the center of two-dimensional material layer 1 in second direction Y and that extends along first direction X.

Second end surface 1bs has, for example, a pair of opposed surface portions opposed to each other in second direction Y.

A total area of second end surface 1bs of second portion 1b is larger than a total area of first end surface las of first portion la. From a different viewpoint, it can be said that when viewed in a plan view, the total width of second portion 1b in second direction Y is smaller than the total width of first portion 1a in second direction Y.

An occupied area of second portion 1b when electromagnetic wave detector 106 is viewed in a plan view is smaller than an occupied area of second portion 1b when electromagnetic wave detector 100 is viewed in a plan view. An area of a contact surface between second portion 1b and semiconductor layer 4 in electromagnetic wave detector 106 is smaller than an area of a contact surface between second portion 1b and semiconductor layer 4 in electromagnetic wave detector 100. The minimum value of the total width of second portion 1b in second direction Y is narrower than the minimum width of each of first portion 1a, fourth portion 1d, and third portion 1c in second direction Y.

As shown in FIG. 17, the planar shape of second portion 1b may be a lattice shape. In two-dimensional material layer 1 shown in FIG. 17, a plurality of openings 12 are formed to expose semiconductor layer 4, and the plurality of openings 12 are arranged side by side in each of the long-side direction and the short-side direction of semiconductor layer 4. Also in two-dimensional material layer 1 shown in FIG. 17, the minimum value of the total width of second portion 1b in second direction Y is narrower than the minimum width of each of first portion 1a, fourth portion 1d, and third portion 1c in second direction Y.

Further, the planar shape of second portion 1b may be an E shape. Each of the plurality of slits 11 may not extend to the boundary between second portion 1b and third portion 1c, for example.

### Functions and Effects

In electromagnetic wave detector 106 shown in FIGS. 16 and 17, the area of the contact surface between second portion 1b and semiconductor layer 4 can be adjusted in accordance with the planar shape of second portion 1b. Therefore, in electromagnetic wave detector 106, the contact resistance between second portion 1b of two-dimensional material layer 1 and semiconductor layer 4, and consequently, the resistance of electromagnetic wave detector 106 can be adjusted. As a result, in electromagnetic wave detector 106, variation in property of electromagnetic wave detector 106 can be reduced and dark current can be reduced as compared with electromagnetic wave detector 100 shown in FIGS. 1 and 2.

In electromagnetic wave detector 106, the total area of second end surface 1bs of second portion 1b is larger than the total area of first end surface las of first portion 1a. Second end surface 1bs extends along a thickness direction of two-dimensional material layer 1, in other words, a direction orthogonal to the two-dimensional plane in which atoms are two-dimensionally arranged in two-dimensional material layer 1. Therefore, the end surface region of the two-dimensional crystal structure in second portion 1b of electromagnetic wave detector 106 is larger than the end surface region of the two-dimensional crystal structure in second portion 1b of electromagnetic wave detector 100. Therefore, in electromagnetic wave detector 106, a proportion of dangling bonds of the two-dimensional crystal structure is increased in second end surface 1bs of second portion 1b as compared with electromagnetic wave detector 100. As a result, when carriers generated in semiconductor layer 4 by application of electromagnetic wave are transported to first electrode portion 2a via two-dimensional material layer 1, a ratio of change in carrier density in two-dimensional material layer 1 of electromagnetic wave detector 106 is increased as compared with two-dimensional material layer 1 of electromagnetic wave detector 100, with the result that the carrier mobility is increased to result in an increased amount of change in current I. As a result, the sensitivity of electromagnetic wave detector 106 is higher than the sensitivity of electromagnetic wave detector 100.

In each modification of the present embodiment described above, second portion 1b of two-dimensional material layer 1 may be composed of a graphene nanoribbon. The graphene nanoribbon has a bandgap that is changed in accordance with its width. Therefore, the wavelength range of the electromagnetic wave that can be subjected to photoelectric conversion in second portion 1b can be adjusted in accordance with the width of second portion 1b composed of the graphene nanoribbon in first direction X. For example, the wavelength range of the electromagnetic wave that can be subjected to photoelectric conversion in second portion 1b may be narrower than the wavelength range of the electromagnetic wave that can be subjected to photoelectric conversion in each of first portion 1a, third portion 1c, and fourth portion 1d. In this case, the photo carriers generated by the photoelectric conversion in second portion 1b can be detected separately from the photo carriers generated by photoelectric conversion in each of first portion 1a, third portion 1c, and fourth portion 1d. Further, by detecting the photo carriers generated by the photoelectric conversion in second portion 1b, the sensitivity of electromagnetic wave detector 106 is improved. Further, in such an electromagnetic wave detector 106, second portion 1b composed of the graphene nanoribbon and semiconductor layer 4 are in Schottky junction with each other to reduce dark current and the sensitivity is improved by detecting the photo carriers generated by the electromagnetic wave absorbed in the Schottky junction.

Here, the configuration of the electromagnetic wave detector according to the present embodiment can also be applied to other embodiments.

### Eighth Embodiment

### Configuration of Electromagnetic Wave Detector

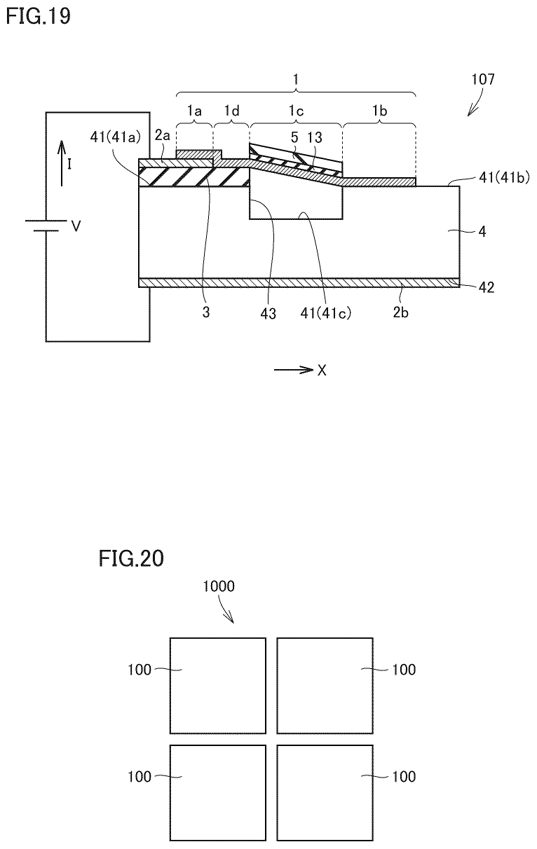

FIG. 18 is a schematic plan view of an electromagnetic wave detector 107 according to an eighth embodiment. FIG. 19 is a schematic cross sectional view along a line segment XIX-XIX in FIG. 18.

Electromagnetic wave detector 107 shown in FIGS. 18 and 19 basically has the same configuration and the same effect as those of electromagnetic wave detector 100 shown in FIGS. 1 and 2, but is different from electromagnetic wave detector 100 shown in FIGS. 1 and 2 in that electromagnetic wave detector 107 further includes a close-contact layer 13 disposed between third portion 1c of two-dimensional material layer 1 and ferroelectric layer 5. The following mainly describes the difference between electromagnetic wave detector 107 and electromagnetic wave detector 100.

As shown in FIG. 19, when viewed in a cross sectional view, close-contact layer 13 is disposed to be sandwiched between third portion 1c of two-dimensional material layer 1 and ferroelectric layer 5. Close-contact layer 13 is disposed in contact with a whole of each of third portion 1c of two-dimensional material layer 1 and ferroelectric layer 5. It should be noted that close-contact layer 13 may be disposed in contact with a portion of each of third portion 1c of two-dimensional material layer 1 and ferroelectric layer 5.

A material of close-contact layer 13 includes at least one selected from insulating materials formed by an ALD (Atomic Layer Deposition) method, a CVD (Chemical Vapor Deposition) method, and a sputtering method. The material of close-contact layer 13 is, for example, alumina formed by the ALD method. In the method of manufacturing electromagnetic wave detector 107, close-contact layer 13 is formed on third portion 1c of the two-dimensional material layer before forming ferroelectric layer 5, for example. Ferroelectric layer 5 is formed on close-contact layer 13 after forming close-contact layer 13, for example. It should be noted that close-contact layer 13 and ferroelectric layer 5 may be continuously formed and may be then continuously patterned using the same mask pattern.

As shown in FIG. 19, basically, electromagnetic wave detector 107 is electrically connected to a power supply circuit as with electromagnetic wave detector 100, and can be operated in the same manner as electromagnetic wave detector 100.

### Functions and Effects

In electromagnetic wave detector 107 according to the present embodiment, improved close contact between third portion 1c and ferroelectric layer 5 is attained by close-contact layer 13 disposed between third portion 1c of two-dimensional material layer 1 and ferroelectric layer 5 as compared with electromagnetic wave detector 100 including no close-contact layer 13. As a result, variation in property among electromagnetic wave detectors 107 each serving as a detection element is reduced, and production yield is improved. Specifically, regarding the variation in property, when the film formation temperature of ferroelectric layer 5 and the driving temperature of electromagnetic wave detector 107 during the operation thereof are different from each other, thermal stress corresponding to the difference between the film formation temperature and the driving temperature is generated in ferroelectric layer 5, thereby causing deformation and resistance change of third portion 1c of the two-dimensional material layer. Even in such a case, the deformation is suppressed and the resistance change is reduced because electromagnetic wave detector 107 includes close-contact layer 13, with the result that the variation in property can be reduced. Further, regarding the production yield, detachment between third portion 1c of two-dimensional material layer 1 and ferroelectric layer 5 may be caused in electromagnetic wave detector 100 including no close-contact layer 13 due to electrostatic induction and charge distribution caused when forming ferroelectric layer 5. On the other hand, in electromagnetic wave detector 107, close-contact layer 13 formed between third portion 1c of two-dimensional material layer 1 and ferroelectric layer 5 neutralizes the charge distribution on the surface of ferroelectric layer 5. Thus, in electromagnetic wave detector 107, the detachment between third portion 1c of the two-dimensional material layer and ferroelectric layer 5 is suppressed, and the production yield of electromagnetic wave detector 107 can be improved.

Here, the configuration of the electromagnetic wave detector according to the present embodiment can also be applied to other embodiments.

### Ninth Embodiment

### Configuration of Electromagnetic Wave Detector Array

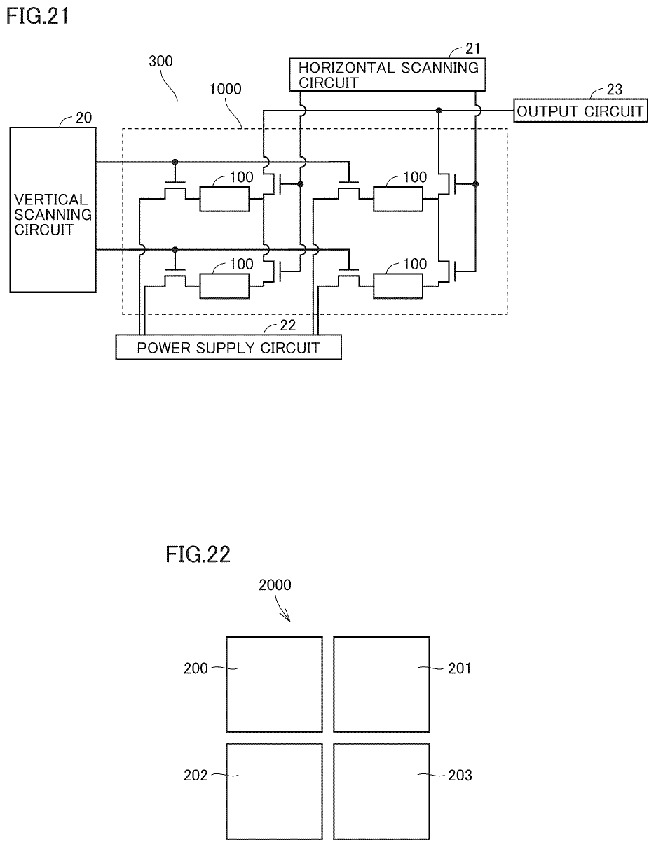

FIG. 20 is a top view of an electromagnetic wave detector array according to a ninth embodiment. FIG. 21 is a schematic diagram showing an exemplary reading circuit to read out an electric signal obtained from the electromagnetic wave detector array according to the ninth embodiment. FIG. 22 is a top view showing a first modification of the electromagnetic wave detector array according to the ninth embodiment.

As shown in FIG. 20, electromagnetic wave detector array 1000 according to the ninth embodiment is a collection of a plurality of electromagnetic wave detectors 100. Electromagnetic wave detector array 1000 has a plurality of electromagnetic wave detectors 100 according to any one of the first to eighth embodiments as detection elements. Electromagnetic wave detector array 1000 includes, for example, the electromagnetic wave detectors according to the first embodiment as electromagnetic wave detectors 100.

In electromagnetic wave detector array 1000, the detection wavelengths for the plurality of electromagnetic wave detectors 100 are the same. As shown in FIG. 20, in electromagnetic wave detector array 1000, the plurality of electromagnetic wave detectors 100 are arranged in the form of an array in the two-dimensional direction. In other words, the plurality of electromagnetic wave detectors 100 are arranged side by side in the first direction and the second direction intersecting the first direction. In electromagnetic wave detector array 1000 shown in FIG. 20, four electromagnetic wave detectors 100 are disposed in the form of an array of 2×2. However, the number of electromagnetic wave detectors 100 disposed is not limited thereto. For example, the plurality of electromagnetic wave detectors 100 may be disposed in the form of an array of 3 or more×3 or more.

It should be noted that in electromagnetic wave detector array 1000 shown in FIG. 20, the plurality of electromagnetic wave detectors 100 are periodically arranged two-dimensionally; however, the plurality of electromagnetic wave detectors 100 may be periodically arranged along one direction. Further, the space between the plurality of electromagnetic wave detectors 100 may be the same or different.

Further, when the plurality of electromagnetic wave detectors 100 are disposed in the form of an array, second electrode portions 2b may be common electrodes as long as electromagnetic wave detectors 100 can be separated from one another. Since second electrode portions 2b are common electrodes, wirings for pixels can be reduced as compared with a configuration in which second electrode portions 2b are independent in respective electromagnetic wave detectors 100. As a result, resolution of the electromagnetic wave detector array can be high.

As a method of separating the plurality of electromagnetic wave detectors 100, for example, the opening structure or the like of semiconductor layer 4 as described in the first embodiment may be provided in the outer periphery of each of electromagnetic wave detectors 100.

Electromagnetic wave detector array 1000 thus including the plurality of electromagnetic wave detectors 100 can be used as an image sensor by arranging the plurality of electromagnetic wave detectors 100 in the form of an array.

Electromagnetic wave detector array 1000 may include any of the electromagnetic wave detectors according to the second to seventh embodiments as electromagnetic wave detectors 100. Electromagnetic wave detector array 1000 may include any of the electromagnetic wave detectors according to the second to eighth embodiments as electromagnetic wave detectors 100.

Electromagnetic wave detector array 1000 may include a plurality of the electromagnetic wave detectors according to any one of the first to eighth embodiments, or may include a plurality of the electromagnetic wave detectors according to two or more of the first to eighth embodiments.

A detection circuit such as a reading circuit or matrix selection circuit to read out an electric signal obtained from each of electromagnetic wave detectors 100 is preferably installed outside electromagnetic wave detector array 1000. Further, the detection circuit such as the reading circuit or matrix selection circuit may be provided on another semiconductor chip and may be electrically connected to electromagnetic wave detector array 1000 by a bump or the like.

FIG. 21 is a schematic diagram showing an example of such a detection circuit, a whole of which is denoted by 300. Hereinafter, each electromagnetic wave detector 100 included in electromagnetic wave detector array 1000 is also referred to as “pixel”. Detection circuit 300 includes: a vertical scanning circuit 20 that scans pixels 100 of electromagnetic wave detector array 1000 in the vertical direction; a horizontal scanning circuit 21 that scans pixels 100 in the horizontal direction; a power supply circuit 22 that supplies bias voltage to each circuit; and an output circuit 23 that outputs a signal from horizontal scanning circuit 21 to outside of electromagnetic wave detector array 1000.

Detection circuit 300 detects a response of electromagnetic wave detector 100 per pixel. Specifically, a response of one pixel is read out by applying voltage to vertical scanning circuit 20 to select one row and applying voltage to horizontal scanning circuit 21 to select one column. By fixing the row selected by vertical scanning circuit 20 and sequentially applying voltage to horizontal scanning circuit 21, all the pixel responses of the row are read out. Then, similarly, by applying voltage to vertical scanning circuit 20 to select another row and sequentially applying voltage to horizontal scanning circuit 21, all the pixel responses of the other row are read out. By repeating this, all the responses of the pixels can be read out.

Although the method of reading out the response per pixel using vertical scanning circuit 20 and horizontal scanning circuit 21 has been described in the present embodiment, it is not limited thereto and the responses may be read per row or per column or another method may be used.

### Modification

An electromagnetic wave detector array 2000 shown in FIG. 22 has basically the same configuration and the same effect as those of electromagnetic wave detector array 1000 shown in FIG. 20, but is different from the electromagnetic wave detector array shown in FIG. 20 in that different types of electromagnetic wave detectors 200, 201, 202, 203 are provided as the plurality of electromagnetic wave detectors.

Each of electromagnetic wave detectors 200, 201, 202, 203 is an electromagnetic wave detector according to any one of the first to seventh embodiments. Electromagnetic wave detectors 200, 201, 202, 203 include, for example, two groups of electromagnetic wave detectors different in detection wavelength. Electromagnetic wave detector array 2000 can detect two or more electromagnetic waves having different wavelengths.

In electromagnetic wave detector array 2000, different types of electromagnetic wave detectors 200, 201, 202, 203 are arranged in the form of an array (matrix).

In electromagnetic wave detector array 2000 shown in FIG. 22, electromagnetic wave detectors 200, 201, 202, 203 are disposed in the form of a matrix of 2×2; however, the number of the electromagnetic wave detectors disposed is not limited thereto. Further, in electromagnetic wave detector array 2000 shown in FIG. 22, the plurality of electromagnetic wave detectors 200, 201, 202, 203 are periodically arranged two-dimensionally; however, the plurality of electromagnetic wave detectors 200, 201, 202, 203 may be periodically arranged along one direction. Further, the spaces between the plurality of electromagnetic wave detectors 200, 201, 202, 203 may be the same or different.

Such an electromagnetic wave detector array 2000 can have a function as an image sensor because different types of electromagnetic wave detectors 200, 201, 202, 203 are disposed in the form of an array.

Since electromagnetic wave detectors 200, 201, 202, 203 thus different in detection wavelengths are disposed in the form of an array, the wavelength of an electromagnetic wave can be identified in any wavelength range such as an ultraviolet light wavelength range, an infrared light wavelength range, a terahertz wave wavelength range, and an electric wave wavelength range, as with the image sensor used in the visible light range. As a result, a color image in which a difference in wavelength is represented as a difference in color can be obtained.

As the constituent material of semiconductor layer 4 included in the electromagnetic wave detector, semiconductor materials different in detection wavelengths may be used. For example, a semiconductor material for a detection wavelength corresponding to the wavelength of the visible light and a semiconductor material for a detection wavelength corresponding to the wavelength of the infrared light may be used as the constituent material. In this case, for example, when the electromagnetic wave detector is applied to a vehicle-mounted sensor, the electromagnetic wave detector can be used as a camera for visible light image in the daytime. Further, the electromagnetic wave detector can be used as an infrared camera at night. In this way, cameras having image sensors do not need to be selectively used in accordance with a detection wavelength of an electromagnetic wave.

As each of other purposes of use of the electromagnetic wave detector than the image sensor, for example, the electromagnetic wave detector can be used as a position detection sensor that can detect a position of an object even with a small number of pixels. For example, an image sensor to detect intensities of electromagnetic waves having a plurality of wavelengths can be obtained by using electromagnetic wave detectors 200, 201, 202, 203 for different detection wavelengths in accordance with the structure of the electromagnetic wave detector array as described above. Thus, a color image can be obtained by detecting electromagnetic waves of a plurality of wavelengths without using a color filter, which has been conventionally required in a CMOS image sensor or the like.

Further, by arraying electromagnetic wave detectors 200, 201, 202, 203 to detect different polarizations, a polarization identification image sensor can be formed. For example, polarization imaging can be achieved by disposing a plurality of electromagnetic wave detectors based on four pixels as one unit, the four pixels detecting polarization angles of 0°, 90°, 45°, and 135°. By the polarization identification image sensor, identification between an artificial object and a natural object, identification of a material, identification of objects having the same temperature in an infrared wavelength range, identification of a boundary between objects, or improvement of equivalent resolution can be achieved, for example.

As described above, electromagnetic wave detector array 2000 can detect an electromagnetic wave in a wide wavelength range. Further, electromagnetic wave detector array 2000 can detect electromagnetic waves having different wavelengths.

### Modification

It should be noted that in each of the above-described embodiments, it is preferable to use, as each of the materials of insulating layer 3, semiconductor layer 4, ferroelectric layer 5, conductor 9, and contact layer 10, a material having a property that is changed by application of an electromagnetic wave to provide a change in potential to two-dimensional material layer 1.

Here, examples of the material having a property that is changed by application of an electromagnetic wave to provide a change in potential to two-dimensional material layer 1 include a quantum dot, a ferroelectric material, a liquid crystal material, a fullerene, a rare earth oxide, a semiconductor material, a pn junction material, a metal-semiconductor junction material, a metal-insulator-semiconductor junction material, and the like. For example, when a ferroelectric material having a polarization effect (pyroelectric effect) by an electromagnetic wave is used as the ferroelectric material, a change in polarization occurs in the ferroelectric material by application of the electromagnetic wave. As a result, a change in potential can be provided to two-dimensional material layer 1.

As described above, when each of the materials of insulating layer 3, semiconductor layer 4, ferroelectric layer 5, conductor 9, and contact layer 10 is the material having a property that is changed by application of the electromagnetic wave, each of the properties of insulating layer 3, semiconductor layer 4, ferroelectric layer 5, conductor 9, and contact layer 10 is changed by application of the electromagnetic wave, with the result that a change in potential can be provided to two-dimensional material layer 1.

It has been illustratively described that the material having a property that is changed by application of an electromagnetic wave to provide a change in potential to two-dimensional material layer 1 is applied to each of insulating layer 3, semiconductor layer 4, ferroelectric layer 5, conductor 9, and contact layer 10; however, the material having a property that is changed by application of an electromagnetic wave to provide a change in potential to two-dimensional material layer 1 may be applied to at least one of the above-described members. For example, when the material having a property that is changed by application of an electromagnetic wave to provide a change in potential to two-dimensional material layer 1 is applied to contact layer 10, contact layer 10 does not need to be necessarily in direct contact with two-dimensional material layer 1. For example, contact layer 10 may be provided on the upper surface or lower surface of two-dimensional material layer 1 with an insulating film or the like being interposed therebetween, as long as the change in potential can be provided to two-dimensional material layer 1.

Each of the above-described embodiments can be appropriately modified or omitted. Further, each of the above-described embodiments can be variously modified in an implementation stage without departing from the gist thereof. Further, each of the above-described embodiments includes disclosures in various stages, and various disclosures can be extracted by appropriately combining a plurality of disclosed constituent elements.

The embodiments disclosed herein are illustrative and non-restrictive in any respect. At least two of the embodiments disclosed herein may be combined unless they are contradictory. The scope of the present disclosure is defined by the terms of the claims, rather than the embodiments described above, and is intended to include any modifications within the scope and meaning equivalent to the terms of the claims.

### REFERENCE SIGNS LIST

1: two-dimensional material layer; 1a: first portion; las: first end surface; 1b second end surface; 1bs: second end surface; 1c: third portion; 1d: fourth portion; 1e: fifth portion; 2a: first electrode portion; 2b: second electrode portion; 2c: third electrode portion; 2d: fourth electrode portion; 3: insulating layer; 4: semiconductor layer; 5: ferroelectric layer; 6: second two-dimensional material layer; 7: second insulating layer; 8: reflective film; 9: conductor; 10: contact layer; 11: slit; 12: opening; 13: close-contact layer; 20: vertical scanning circuit; 21: horizontal scanning circuit; 22: power supply circuit; 23: output circuit; 41: first surface; 41a: first region; 41b: second region; 41c: third region; 42: second surface; 43: recess; 100, 101, 102, 103, 104, 105, 106, 200, 201, 202, 203: electromagnetic wave detector; 300: detection circuit; 1000, 2000: electromagnetic wave detector array.

1. An electromagnetic wave detector comprising:
a two-dimensional material layer having a first portion, a second portion, and a third portion, the second portion being disposed with a space being interposed between the first portion and the second portion in a first direction, the third portion being bridged between the first portion and the second portion in the first direction;
a first electrode portion electrically connected to the first portion;
a second electrode portion electrically connected to the first electrode portion via the first portion, the third portion, and the second portion of the two-dimensional material layer;
a ferroelectric layer at least having a portion disposed on the third portion, and
a close-contact layer disposed between the third portion and the ferroelectric layer.

2. The electromagnetic wave detector according to claim 1, wherein the ferroelectric layer is provided to change a resistance value of the two-dimensional material layer when polarization in the ferroelectric layer is changed.

3. (canceled)

4. The electromagnetic wave detector according to claim 1, further comprising:
a second two-dimensional material layer disposed to sandwich the ferroelectric layer between the second two-dimensional material layer and the third portion; and
a third electrode portion electrically connected to the second two-dimensional material layer.

5. An electromagnetic wave detector comprising:
a two-dimensional material layer having a first portion, a second portion, and a third portion, the second portion being disposed with a space being interposed between the first portion and the second portion in a first direction, the third portion being bridged between the first portion and the second portion in the first direction;
a first electrode portion electrically connected to the first portion;
a second electrode portion electrically connected to the first electrode portion via the first portion, the third portion, and the second portion of the two-dimensional material layer;
a ferroelectric layer at least having a portion disposed on the third portion, and
a semiconductor layer having a first surface and a second surface located opposite to the first surface, wherein
the first surface has a first region, a second region, and a third region, the second region being disposed with a space being interposed between the first region and the second region in the first direction, the third region being disposed between the first region and the second region in the first direction,
the electromagnetic wave detector further comprising an insulating layer disposed on the first region, the second region and the third region being exposed from the insulating layer, wherein
the first portion of the two-dimensional material layer and the first electrode portion are disposed on the insulating layer,
the second portion of the two-dimensional material layer is in contact with the second region,
the third portion of the two-dimensional material layer is disposed with a space being interposed between the third portion and the third region in a direction orthogonal to the first surface, and
the second electrode portion is in contact with the second surface, and is electrically connected to the first electrode portion via the first portion, the third portion and the second portion of the two-dimensional material layer, and the semiconductor layer.

6. The electromagnetic wave detector according to claim 5, wherein the first portion has a first end surface extending in a direction intersecting the first surface,
the second portion has a second end surface extending in the direction intersecting the first surface, and
a total area of the second end surface is larger than a total area of the first end surface.

7. An electromagnetic wave detector comprising:
a two-dimensional material layer having a first portion, a second portion, and a third portion, the second portion being disposed with a space being interposed between the first portion and the second portion in a first direction, the third portion being bridged between the first portion and the second portion in the first direction;
a first electrode portion electrically connected to the first portion;
a second electrode portion electrically connected to the first electrode portion via the first portion, the third portion, and the second portion of the two-dimensional material layer:
a ferroelectric layer at least having a portion disposed on the third portion, and
a supporting layer having a first surface, wherein
the first surface has a first region, a second region, and a third region, the second region being disposed with a space being interposed between the first region and the second region in the first direction, the third region being disposed between the first region and the second region in the first direction,
the electromagnetic wave detector further comprising:
a first insulating layer disposed on the first region; and
a second insulating layer disposed on the second region, wherein
the first portion of the two-dimensional material layer and the first electrode portion are disposed on the first insulating layer,
the second portion of the two-dimensional material layer and the second electrode portion are disposed on the second insulating layer, and
the third portion of the two-dimensional material layer is disposed with a space being interposed between the third portion and the third region in a direction orthogonal to the first surface.
the electromagnetic wave detector further comprising a reflective film disposed on the third region.

8. (canceled)

9. The electromagnetic wave detector according to claim 1, further comprising a conductor in contact with at least one of the third portion of the two-dimensional material layer and the ferroelectric layer.

10. The electromagnetic wave detector according to claim 1, further comprising a contact layer in contact with the two-dimensional material layer, wherein
the contact layer is provided to dope the two-dimensional material layer with an electron or positive hole.

11. The electromagnetic wave detector according to claim 1, further comprising at least one of a voltmeter and an ammeter, wherein
the two-dimensional material layer, the first electrode portion, and the second electrode portion are electrically connected in an order of the first electrode portion, the first portion of the two-dimensional material layer, the third portion of the two-dimensional material layer, the second portion of the two-dimensional material layer, and the second electrode portion, and
at least one of the voltmeter and the ammeter detects an electromagnetic wave by detecting a change in at least one of a voltage of a current and the current, the current flowing between the first electrode portion and the second electrode portion.

12. The electromagnetic wave detector according to claim 1, wherein the two-dimensional material layer includes a turbostratic structure portion.

13. The electromagnetic wave detector according to claim 1, wherein the two-dimensional material layer includes any material selected from a group consisting of transition metal dichalcogenide, graphene, black phosphorus, silicene, germanene, graphene nanoribbon, and borophene.

14. An electromagnetic wave detector array comprising a plurality of the electromagnetic wave detectors according to claim 1, wherein
the plurality of the electromagnetic wave detectors are disposed side by side along at least one of the first direction and a second direction intersecting the first direction.

15. The electromagnetic wave detector according to claim 5, wherein the ferroelectric layer is provided to change a resistance value of the two-dimensional material layer when polarization in the ferroelectric layer is changed.

16. The electromagnetic wave detector according to claim 7, wherein the ferroelectric layer is provided to change a resistance value of the two-dimensional material layer when polarization in the ferroelectric layer is changed.

17. The electromagnetic wave detector according to claim 5, further comprising a conductor in contact with at least one of the third portion of the two-dimensional material layer and the ferroelectric layer.

18. The electromagnetic wave detector according to claim 7, further comprising a conductor in contact with at least one of the third portion of the two-dimensional material layer and the ferroelectric layer.

19. The electromagnetic wave detector according to claim 5, further comprising a contact layer in contact with the two-dimensional material layer, wherein
the contact layer is provided to dope the two-dimensional material layer with an electron or positive hole.

20. The electromagnetic wave detector according to claim 7, further comprising a contact layer in contact with the two-dimensional material layer, wherein
the contact layer is provided to dope the two-dimensional material layer with an electron or positive hole.
